(19) United States
(12) Patent Application Publication
(10) Pub. No.: US 2026/0289123 A1
(43) Pub. Date: Sep. 24, 2026

(54) SYSTEM

(71) Applicant: SoftBank Group Corp., Tokyo (JP)

(72) Inventor: Shizuka GOTO, Tokyo (JP)

(73) Assignee: SoftBank Group Corp., Tokyo (JP)

(21) Appl. No.: 19/564,293

(22) Filed: Mar. 12, 2026

(30) Foreign Application Priority Data
Mar. 19, 2025 (JP) 2025-045041

(51) Int. Cl. G06F 40/284; G06F 3/01; G06F 16/387; G06F 40/205; G06F 40/295; G06N 3/0475

(52) U.S. Cl. CPC G06F 40/284; G06F 3/011; G06F 16/387; G06F 40/205; G06F 40/295; G06N 3/0475; G06F 2203/011

(57) ABSTRACT

A system includes a processor that is configured to use a generative AI model, in response to a prompt, to receive and analyze information from a user and to determine a current location of the user, use the generative AI model, in response to a prompt, to extract a request of the user, to generate a plurality of options corresponding to the request, to analyze an emotion of the user, and to adjust a conversation with the user based on the analyzed emotion.

### CROSS-REFERENCE TO RELATED APPLICATION

This application is based on and claims priority under 35 USC 119 from Japanese Patent Application No. 2025-045041 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional interactive systems that utilize generative AI models for user support are not sufficiently adapted to location-dependent and context-sensitive use cases. In particular, such systems often fail to accurately determine a current location of a user based solely on natural language interaction, and therefore cannot appropriately personalize location-based recommendations. Furthermore, known systems generally do not extract a user's detailed request in a structured manner, and do not generate multiple tailored options corresponding to the extracted request. As a result, the user is forced to repeatedly refine the query manually, which reduces usability.

In addition, conventional systems rarely analyze a user's emotional state and thus cannot dynamically adjust an ongoing conversation according to changes in the user's emotion. This leads to inflexible or inappropriate responses, especially for users who feel anxiety or frustration when searching for places in unfamiliar environments. Moreover, when a user's request relates to dining facilities, existing systems often present only a limited number of unstructured results, without reflecting the nuances of the user's preferences or emotional state. The situation is even more problematic for users who have difficulty reading maps, since typical systems present location information mainly in map form and do not generate options that are specifically adapted to such users.

Accordingly, there is a need for an improved system that uses a generative AI model not only to interpret user input, but also to determine a user's current location, to extract and structure the user's request, to generate multiple options corresponding to that request, and to analyze and respond to the user's emotional state. There is a further need for such a system to generate multiple dining facility options when the user's request relates to dining, and to generate options including map-related location information in a form that is suitable for users who have difficulty reading maps.

### SUMMARY

In order to solve the above-described problems, according to one aspect, there is provided a system comprising a processor, wherein the processor is configured to use a generative AI model, in response to a prompt, to receive and analyze information from a user and to determine a current location of the user. By causing the processor to input one or more prompts to the generative AI model on the basis of user-provided natural language and contextual information, the system enables the generative AI model to infer or refine the user's current location, even when explicit location data is incomplete or unavailable.

The processor is further configured to use the generative AI model, in response to a prompt, to extract a request of the user and to generate a plurality of options corresponding to the request. In particular, the processor structures the user's request into one or more parameters, such as a type of facility, a preference condition, or a constraint, and then causes the generative AI model to generate multiple candidate options that satisfy the structured request.

The processor is also configured to use the generative AI model, in response to a prompt, to analyze an emotion of the user on the basis of the user's utterances or interaction history, and to adjust a conversation with the user based on the analyzed emotion. Thus, the system modifies tone, level of detail, or style of guidance according to changes in the user's emotional state.

In one embodiment, when the request of the user relates to a dining facility, the processor is configured to use the generative AI model, in response to a prompt, to generate a plurality of pieces of dining facility information as the plurality of options. The generated dining facility information may include, for example, facility names, categories, price ranges, and qualitative explanations adapted to the user's preferences and emotional condition. In another embodiment, when the request of the user is provided for a user who has difficulty reading a map, the processor is configured to use the generative AI model, in response to a prompt, to generate the plurality of options including location information on a map, such as route descriptions, landmark-based guidance, or simplified textual indications that are easier to understand than conventional map displays. Through these configurations, the system enables context-aware, emotion-sensitive, and user-adaptive provision of multiple location-based options by leveraging a generative AI model.

The term “system” refers to a combination of one or more hardware and software components, including at least one processor and associated memory, configured to execute programs that implement the functions recited in the claims.

The term “processor” refers to one or more hardware processing units, such as a central processing unit (CPU), a graphics processing unit (GPU), a digital signal processor (DSP), or any combination thereof, capable of executing instructions stored in a memory to perform computational and control operations.

The term “generative AI model” refers to a machine-learned model, such as a large language model or other generative model, that is trained on data to generate outputs including text, numerical values, or structured information in response to input prompts.

The term “prompt” refers to an input sequence provided to the generative AI model, the input sequence including at least natural language text, structured data, or a combination thereof, and serving as a basis for the generative AI model to generate an output.

The term “user” refers to a human individual who interacts with the system by providing information, such as natural language input, and by receiving responses, options, or guidance from the system.

The term “current location of the user” refers to a geographic position associated with the user at a given time, expressed, for example, as coordinates, an address, or a place identifier, and inferred or determined by the system using the generative AI model and related data.

The term “request of the user” refers to an expressed need, intention, query, or preference provided by the user, typically in natural language, which the system interprets and structures for the purpose of generating corresponding options or responses.

The term “plurality of options” refers to two or more candidate responses, facilities, routes, plans, or other selectable alternatives generated by the system in correspondence with the request of the user.

The term “emotion of the user” refers to an emotional state or affective condition of the user, such as satisfaction, frustration, anxiety, or excitement, as inferred by the system from the user's input, behavior, or interaction history.

The term “conversation” refers to an interactive exchange of messages between the user and the system, the exchange including at least user inputs and system-generated outputs, optionally occurring over multiple turns.

The term “dining facility” refers to a place where food or beverages are provided to customers, including, for example, restaurants, cafes, bars, fast-food outlets, and similar establishments.

The term “dining facility information” refers to data related to a dining facility, including at least one of a facility name, category, address, location, price range, opening hours, menu characteristics, ratings, or textual explanations.

The term “location information on a map” refers to information that identifies one or more positions or routes on a geographic map, including at least coordinates, map markers, route indications, landmark descriptions, or textual descriptions that relate to map-based positions.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

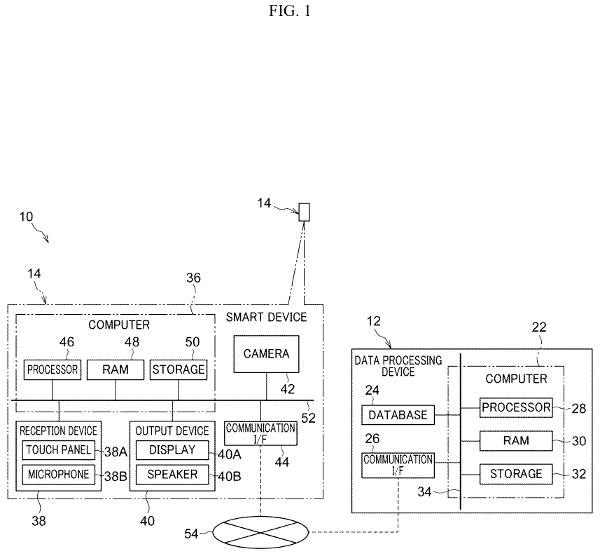

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

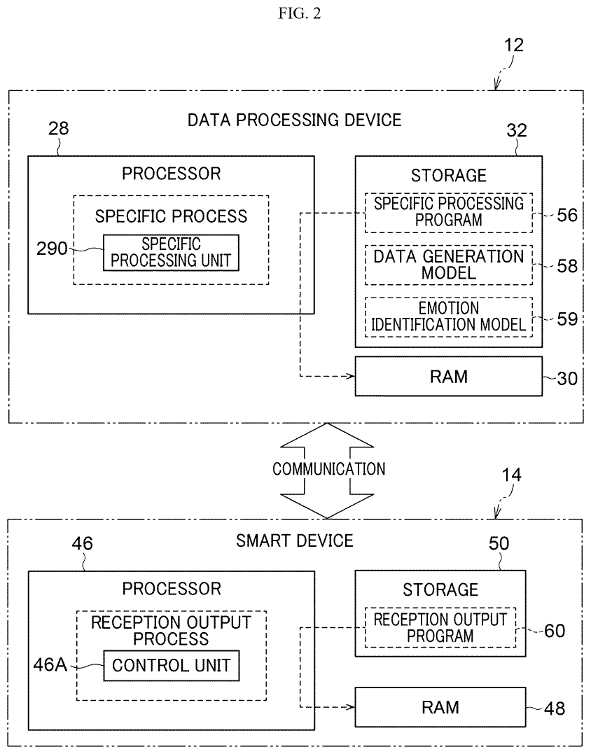

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional map information systems and location-based service systems generally retrieve points of interest in response to simple keyword and coordinate queries. Such systems typically apply fixed, rule-based logic to search geographic databases and return lists of nearby facilities. As a result, these systems exhibit several technical limitations from the viewpoint of computer technology.
First, conventional systems do not effectively integrate natural language understanding with location processing in a unified computational pipeline. The server often treats user input text and position data as independent parameters, resulting in brittle query generation and an increased number of network calls and database queries. This leads to inefficient use of processor resources, increased latency in generating responses, and an inability to adaptively optimize queries in accordance with the user's current context.
Second, conventional systems are not configured to generate optimized prompt sentences for a generative AI model on the server side by jointly considering (i) the parsed intent and target category of the user's natural language inquiry, (ii) the user's current location information, and (iii) conversation context including the user's inferred emotional state. Instead, either no generative AI model is used, or the generative AI model is used in an ad hoc manner, where raw user text is forwarded directly. This causes suboptimal utilization of computing resources of both the server processor and the external AI computing infrastructure, increases token usage and processing time at the generative AI model, and degrades the precision of generated responses, thereby forcing repeated queries and redundant processing.
Third, conventional systems are not configured to algorithmically adapt the generation of responses and the search of geographic information databases based on an analysis of the user's emotional state derived from the user's input expressions. Without such adaptive control, the server cannot efficiently tailor the content, level of detail, and tone of responses, and may generate unnecessarily long or inappropriate answers, which increases processor load, network bandwidth, and user-side rendering overhead.
Fourth, for users who have difficulty reading maps or understanding geographic layouts, conventional systems merely display raw map images or simple route lists. They do not generate multiple options and step-by-step, conversational guidance that is dynamically computed from both geographic data and a generative AI model. Consequently, the server cannot effectively transform low-level geographic data structures and routing information into higher-level, user-adaptive explanation data structures, and must rely on client-side heuristics or static templates, which are not optimized for accessibility or efficiency.

In view of the above, there is a need for an improved computer-implemented system and server-side processing architecture that: (1) tightly integrates natural language inquiry processing, position information processing, and prompt generation for a generative AI model; (2) optimizes the generation and use of prompt sentences to reduce unnecessary computation and improve response accuracy; (3) adaptively controls the content and tone of responses based on user emotion analysis; and (4) produces conversational explanation information and map display data that are especially suitable for users with limited map-reading skills, thereby improving the overall technical performance and usability of map-related information processing on computing devices.

The specific processing by the specific processing unit 290 of the data processing device 12 in Example 1 is realized by the following means.

The present invention provides a server comprising a processor configured to acquire inquiry information expressed in natural language and position information from an information processing terminal operated by a user; analyze an intention and a target category of the inquiry information based on the inquiry information and the position information, and generate a prompt sentence to be input to a generative AI model; input the prompt sentence to the generative AI model and cause the generative AI model to generate response information in natural language to the inquiry information; search an external geographic information database based on the response information and the position information, acquire related information including facility information and position information from the external geographic information database, and integrate the related information with the response information; generate conversational explanation information and map display data based on the response information and the related information, and transmit the conversational explanation information and the map display data to the information processing terminal; and analyze an emotional state of the user from an expression included in the inquiry information, and adjust content or tone of at least one of the prompt sentence and the response information according to the emotional state. This enables the server to implement an integrated, server-centric processing pipeline that (i) reduces redundant queries and processing steps by jointly exploiting natural language input and position information, (ii) optimizes the prompt sentence supplied to the generative AI model to improve response relevance and decrease computation overhead, (iii) dynamically controls the generation of responses and selection of geographic information in accordance with the user's emotional state, and (iv) outputs machine-generated conversational explanation information and map display data that enhance the technical performance and accessibility of map information services, particularly for users who have difficulty understanding conventional map displays.

The term “system” refers to a combination of one or more hardware devices and software components that cooperate to execute the claimed processing, including at least a processor and an information processing terminal connected via a communication network.

The term “processor” refers to one or more hardware processing units, such as a central processing unit or graphics processing unit, that execute computer-readable instructions to perform the claimed functions.

The term “information processing terminal” refers to an electronic device operated by a user, such as a mobile communication terminal, a tablet device, or a personal computer, that is capable of transmitting inquiry information and position information to the server and receiving response information and map display data.

The term “user” refers to a human operator who interacts with the information processing terminal by inputting inquiry information and viewing or otherwise consuming the response information and map display data.

The term “inquiry information” refers to information expressing a question, request, or instruction from the user, typically represented as a natural language text string or an equivalent representation, and provided from the information processing terminal to the server.

The term “natural language” refers to a human language, such as a spoken or written language used for everyday communication, as distinguished from a programming language or formal notation.

The term “position information” refers to data indicating a geographic location associated with the user or a point of interest, including, for example, coordinate information such as latitude and longitude, and optionally accuracy, altitude, or time information.

The term “intention” refers to a semantic meaning or purpose underlying the inquiry information, such as a desire to search for a facility, obtain route guidance, or receive an explanation of a geographic area.

The term “target category” refers to a classification of an object or service that is the subject of the user's inquiry, such as a category of facility, a type of service, or a class of geographic feature.

The term “prompt sentence” refers to a text string or equivalent input data structure generated by the processor and supplied to the generative AI model, the text string specifying instructions, conditions, or context for controlling the operation of the generative AI model.

The term “generative AI model” refers to a machine-learned model, typically implemented as a neural network-based language model, that receives a prompt sentence as input and generates natural language output or other data as a result of probabilistic computation.

The term “response information” refers to information generated by the generative AI model in response to the prompt sentence and processed by the processor, including at least natural language text representing an answer, explanation, or guidance corresponding to the inquiry information.

The term “external geographic information database” refers to a data storage system that is separate from the information processing terminal and maintains geographic information, including, for example, map data, facility information, and location metadata, and that is accessible by the server through a communication network.

The term “facility information” refers to structured information relating to an object or service location, such as a name, address, geographic coordinates, category, opening hours, or rating associated with a facility.

The term “related information” refers to information acquired from the external geographic information database and other sources, including facility information, position information, and additional metadata that are relevant to the user's inquiry and location.

The term “conversational explanation information” refers to response information that has been formatted or generated in a style suitable for interactive, dialogue-based presentation, including, for example, short natural language utterances, step-by-step guidance, or question-and-answer style text.

The term “map display data” refers to data suitable for controlling a map display on the information processing terminal, including at least geographic coordinates, identifiers for markers or routes, and optionally display attributes such as labels, icons, or zoom levels.

The term “emotional state” refers to an estimation of a user's affective condition, such as satisfaction, frustration, anxiety, or confidence, inferred from linguistic expressions, context, or other features contained in the inquiry information.

The term “expression included in the inquiry information” refers to a segment of the inquiry information, such as a word, phrase, sentence, or combination thereof, that is used to infer the user's emotional state or intention.

The term “content or tone” refers to one or both of (i) the substantive information contained in the prompt sentence or response information and (ii) the stylistic characteristics thereof, including politeness level, formality, length, or degree of detail.

The term “food service facility” refers to a type of physical location where food or beverages are provided to customers, such as a restaurant, cafe, bar, or similar establishment.

The term “features of a surrounding environment” refers to characteristics of an area around a position indicated by the position information, including, for example, density or type of facilities, predominant land use, transportation infrastructure, and notable points of interest.

The term “options” refers to a plurality of alternative candidates or choices, such as different facilities, routes, or explanation variants, that are generated by the generative AI model or by the processor based on geographic data and response information.

The term “guidance explanation information” refers to information that explains a movement or route between locations, such as step-by-step route instructions, orientation descriptions, or high-level summaries of how to reach a destination.

In one embodiment, a server cooperates with at least one terminal operated by a user to implement the claimed system. The server includes a processor, a non-transitory memory storing one or more programs, a network interface, and optionally a hardware accelerator such as a graphics processing unit. The terminal includes a processor, a display unit, an input unit, a wireless communication unit, and at least one location sensor such as a Global Positioning System module or a network-based positioning module. The server and the terminal communicate via a communication network using a transport protocol such as Hypertext Transfer Protocol Secure.

The terminal executes a client application, which may be implemented as a web browser executing client-side scripts based on a scripting language, or as a native application executing on a mobile operating system. The client application presents to the user a chat interface and a map display interface. The terminal acquires position information of the user by invoking an operating system location application programming interface, which aggregates sensor signals from a satellite positioning module, a wireless access point locator, and a cellular base station locator. The terminal encodes latitude, longitude, accuracy, and a timestamp into a structured data object in a memory of the terminal, and transmits this data object together with inquiry information expressed in natural language to the server via the network interface.

The server stores, in the non-transitory memory, a plurality of software modules including a network communication module, an inquiry analysis module, a prompt generation module, a generative AI interface module, a geographic database access module, an emotional state analysis module, a response composition module, and a logging and monitoring module. The server executes these modules on the processor according to one or more programs to realize the functions recited in the claims.

The server receives, via the network communication module, the inquiry information and the position information transmitted from the terminal. The server stores the received data in a request buffer implemented in main memory. The server normalizes the position information by converting the latitude and longitude into a standardized coordinate representation, and optionally performs reverse geocoding by transmitting the coordinates to an external geocoding service to obtain a textual representation of the area. The server stores the normalized coordinates and the optional address string in a location context data structure that is associated with a user identifier. p The server analyzes the inquiry information using the inquiry analysis module. The server loads a natural language processing library, for example a statistical or neural sequence tagging model, into memory, and tokenizes the inquiry information into subword units storing the tokens in an array data structure. The server performs part-of-speech tagging and dependency parsing to identify key linguistic elements such as verbs associated with user requests and nouns corresponding to objects of interest. The server maps the parsed linguistic structures to an intention and a target category by applying a trained classifier. In one example, the classifier is implemented as a multilayer neural network that receives as input a sequence of token embeddings and outputs an intention label such as “find_nearby_place,” “explain_area,” or “request_route,” and a target category label such as “food_service_facility,” “accommodation,” or “transportation_hub.” The server stores the intention and the target category in an intention context data structure.

The server generates a prompt sentence using the prompt generation module. The server concatenates, according to a predefined template, the intention, the target category, the normalized position information, and optional reverse-geocoded area descriptors into a text string. The server also embeds system-level constraints such as required response length, style guidelines, and avoidance of hallucinated entities. For example, the server generates a prompt sentence such as:

“The user is currently at latitude 35.6804 and longitude 139.7690. The user asked: ‘Where is the nearest cafe?’. Based on this location and question, identify the cafe that is closest to this location using reliable geographic information, and provide a concise explanation suitable for a map chat interface. Answer in one or two sentences.”

In another example for an area explanation, the server generates a prompt sentence such as: “The user is currently viewing a location near latitude 35.0116 and longitude 135.7681. The user has difficulty reading maps and wants to understand this area. Based on typical geographic and facility information around this location, explain in simple, conversational language whether the area is mainly residential, commercial, or mixed, and what a first-time visitor can expect.”

The server passes the generated prompt sentence to the generative AI interface module. In one embodiment, the generative AI model is a transformer-based neural network language model trained on large-scale text corpora, having multiple self-attention layers, feed-forward layers, and layer normalization. The generative AI model is parameterized by weight matrices stored in a model parameter store, and is trained offline by minimizing a loss function representing prediction error on next-token prediction tasks. The training process uses backpropagation and a stochastic optimization algorithm for weight updates, based on training examples that include context tokens and target tokens. During inference in the claimed system, the server does not update the model weights but uses the trained parameters to compute output tokens.

The server converts the prompt sentence into a token sequence using a tokenizer consistent with the generative AI model's vocabulary, and transmits the token sequence as part of a request to an external or internal inference engine implementing the generative AI model. The inference engine executes on specialized hardware such as a graphics processing unit or a tensor processing unit, which accelerates matrix multiplications in the attention and feed-forward layers. The server receives a sequence of output tokens from the inference engine, decodes the tokens into a natural language text string, and stores the string as response information in a response buffer.

The server analyzes an emotional state of the user using the emotional state analysis module. The server applies an emotion classifier, which may be implemented as a neural network taking as input embeddings of the inquiry information and optionally historical conversation context. The server maps the input features to one or more emotion labels such as “calm,” “confused,” “frustrated,” or “in a hurry,” and to a confidence score. The server stores the emotion label and the confidence score in an emotion context data structure. The server then adjusts the prompt sentence and, if necessary, the response information based on this emotion context. For instance, if the emotion state is “confused,” the server extends the prompt sentence to request more detailed and step-by-step explanations. If the emotion state is “in a hurry,” the server modifies the prompt sentence to request concise, direct answers with minimal auxiliary information. This adjustment uses explicit rules encoded in the prompt generation module and the response composition module, rather than relying solely on human operator judgment, and therefore defines a specific, non-conventional control logic for the generative AI model.

The server searches an external geographic information database using the geographic database access module. The server constructs a query containing the normalized position information, the target category, and search parameters such as radius and maximum number of results. The external geographic information database stores geographic entities in a spatially indexed data structure, such as an R-tree or quad-tree, which enables efficient retrieval of facilities within a specified radius. The server receives structured facility information, including facility names, addresses, geographic coordinates, categories, and opening hours, and stores this facility information in a facility list data structure. The server may cross-reference facility names or attributes appearing in the response information generated by the generative AI model with the facility list to select consistent candidates. This cross-referencing reduces cases where the generative AI model introduces entities that do not correspond to actual geographic entries, thereby improving the accuracy of the overall system.

The server generates conversational explanation information and map display data using the response composition module. The server merges the natural language response information with the facility list by embedding numeric values such as distance and estimated travel time into explanatory sentences. The server optionally re-invokes the generative AI model with an additional prompt sentence that includes a compact representation of the facility list, such as: “Here is structured data for nearby cafes: [facility names, distances, and opening hours summarized in text]. Based on this data, rephrase the previous explanation to mention only the two best options, and make the explanation friendly and easy to understand for a user who is not good at reading maps.”

The server then receives a refined explanation and stores it as conversational explanation information. In parallel, the server constructs map display data by encoding facility coordinates, user coordinates, and display attributes into a data structure suitable for rendering on the terminal. The server includes map marker identifiers, zoom level recommendations, and route hints, which are computed by performing geometric calculations such as distance computation between coordinate pairs and bounding box determination for visible map regions.

The terminal receives the conversational explanation information and the map display data from the server, and stores these in memory. The terminal displays the conversational explanation information as text within a chat user interface, and uses a map rendering software development kit to display markers and optional routes on a digital map. The terminal may highlight the selected facility and adjust the viewport to include both the user location and the facility location, thereby providing a visual representation tied to the server-generated explanation.

In another embodiment, the server provides special support for users having difficulty reading maps. The server detects such users based on prior interaction data or explicit user settings stored in a user profile. For these users, the server configures the prompt sentence to request multiple options and stepwise guidance. For example, the server generates a prompt sentence such as:

“The user is currently at latitude 34.6937 and longitude 135.5023 and has difficulty reading maps. Suggest a simple walking route to the nearest restaurant suitable for a quick lunch, and describe the route in 3 to 5 short steps using prominent landmarks, without relying on map terminology.”

The generative AI model then outputs step-by-step guidance explanation information, which the server post-processes into discrete instruction objects. The terminal displays the instructions in an ordered list and may synchronize each instruction with a highlighted segment on the map. This configuration allows the system to transform lower-level geographic data and route calculations into higher-level, accessible explanation structures that can be processed and followed by users without map literacy.

From the viewpoint of computer technology, the described configuration provides several technical improvements. The server integrates natural language processing, emotion analysis, and geographic query generation in a unified processing pipeline that minimizes redundant external calls and unnecessary data transfers. Because the server generates optimized prompt sentences that include structured context and explicit constraints, the generative AI model produces more targeted responses using fewer tokens and less computation per request. This reduces processing time on the AI inference hardware and decreases network bandwidth consumption between the server and the AI inference engine.

The server further reduces overall latency by using spatial indexing in the geographic database access module, and by cross-validating AI-generated content with structured geographic data. This design avoids repeated or corrective queries that would occur if the generative AI model were used in isolation. Additionally, the emotion-aware adjustment of prompt sentences and response content allows the system to dynamically control the length and complexity of responses based on inferred user state, which reduces the amount of data transmitted to the terminal and the amount of rendering work performed by the terminal. These optimizations are closely tied to the underlying data structures and algorithms, and are not a mere automation of human reasoning.

In one embodiment, the generative AI model uses a transformer architecture with multiple encoder-decoder layers, each layer comprising self-attention sublayers and position-wise feed-forward sublayers. The model receives as input a sequence of token embeddings, where each embedding is computed as the sum of a word embedding vector and a positional encoding vector. During training, the model minimizes a cross-entropy loss between predicted token distributions and ground-truth tokens, using mini-batch stochastic gradient descent with an adaptive learning rate scheduler. The server can be configured to select a specific model variant with predefined numbers of layers, attention heads, and embedding dimensions based on performance and resource constraints. These structural details define a concrete computational engine that processes prompt sentences in a manner different from conventional rule-based engines or simple template-based text generators.

In a further embodiment, the server can replace or supplement the neural intention classifier and emotion classifier with alternative models, such as gradient-boosted decision trees operating on manually engineered features derived from the inquiry text. The server can also vary the spatial index type in the geographic database, using, for example, a k-d tree instead of an R-tree, while preserving the overall flow in which geographic entities are retrieved and validated based on proximity to the user position and semantic match with the target category.

The server can also be configured to operate in a partially offline environment by caching frequently accessed geographic regions and associated facility information in a local database. In such a case, the server reduces dependence on external geographic services, thereby further lowering network usage and improving response time, while still using the generative AI model and the prompt generation module to create context-aware explanations. The ability to adaptively switch between external resources and local caches based on system state is an additional technical effect.

Because the server tightly integrates the prompt generation, generative AI model interaction, geographic database searching, emotional state analysis, and response composition into a coordinated architecture, the system achieves improved processing speed, improved precision of facility recommendation and explanation, reduced communication overhead, and enhanced usability for users with various levels of map literacy. These improvements arise from specific data structures, algorithms, and model configurations implemented in the server, and not from an abstract idea of conversation or business logic alone.

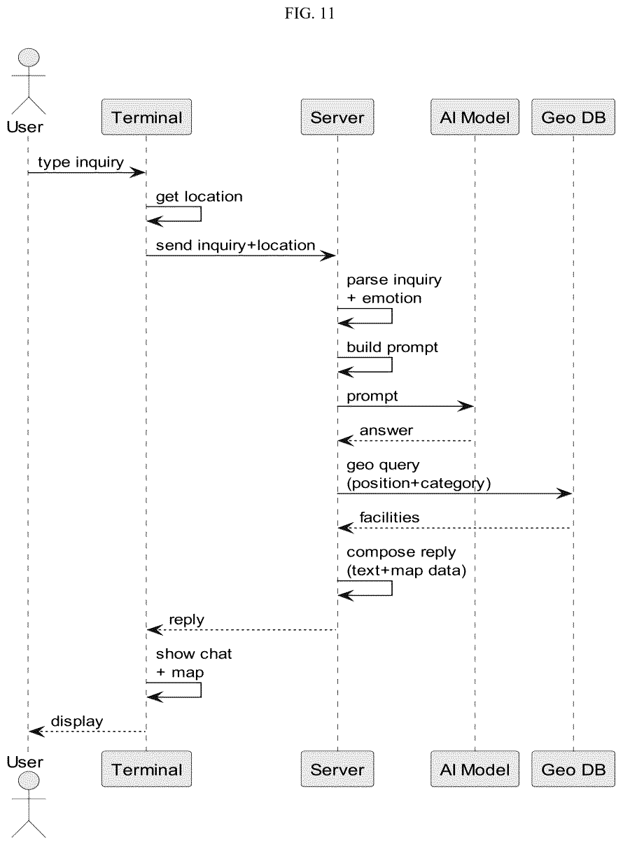

The following describes the processing flow using FIG. 11.
Step 1:

The user operates the terminal to start an application that provides a chat interface and a map interface.

The terminal displays a text input field and a send control element on a display unit.

Input: No external data; the terminal uses internal user interface configuration data.

Output: A rendered user interface state that accepts natural language text from the user.
Step 2:

The user inputs inquiry information expressed in natural language, such as “Where is the nearest cafe?” or “What kind of area is this place?”.

The user activates the send control element.

The terminal acquires the entered text string from an input buffer.

Input: Raw keystroke or touch events from the input unit.

Data processing: The terminal aggregates the events into a complete text string, trims whitespace, and encodes the text in a character encoding such as UTF-8.

Output: A validated inquiry text string stored in a request object in memory.
Step 3:

The terminal acquires position information of the user.

The terminal calls an operating system location API, which aggregates signals from a Global Positioning System module, wireless access points, and cellular base stations.

Input: Sensor readings (satellite signals, signal strengths, network identifiers) provided by hardware modules and the operating system.

Data processing: The terminal fuses these readings using a location estimation algorithm (for example, weighted least squares or Kalman filtering implemented by the OS) and obtains latitude, longitude, accuracy, and timestamp.

Output: A position information object containing numeric coordinates and metadata, which the terminal attaches to the request object together with the inquiry text.
Step 4:

The terminal transmits the inquiry information and the position information to the server.

The terminal serializes the request object into a structured format, such as JSON, and creates a Hypertext Transfer Protocol Secure request.

Input: Inquiry text string and position information object stored in terminal memory.

Data processing: The terminal maps the internal fields to key-value pairs, compresses the payload if required, and encrypts the communication via Transport Layer Security.

Output: An HTTPS request containing the inquiry and position information sent through a network interface to the server.
Step 5:

The server receives the request from the terminal.

The server's network communication module accepts the HTTPS request, decrypts the payload, and parses the structured format.

Input: Encrypted network packets received by the network interface.

Data processing: The server performs TLS decryption, HTTP parsing, and JSON decoding to reconstruct a request object containing the inquiry text and position information. The server validates data types and coordinate ranges.

Output: A normalized request object stored in server memory, including a natural language string and a numeric coordinate pair.
Step 6:

The server normalizes and augments the position information.

The server converts the received latitude and longitude into a standardized geographic coordinate representation, optionally including a spatial reference identifier.

Input: Raw latitude, longitude, and accuracy values.

Data processing: The server rounds coordinates to a controlled precision, encapsulates them into a geographic point structure, and, if enabled, queries a reverse geocoding service to obtain an area name or address. The server may cache this information in a location context data structure.

Output: A location context that includes a geographic point, an optional region name, and quality indicators.
Step 7:

The server analyzes the inquiry information to determine the user's intention and target category.

The server invokes an inquiry analysis module, which loads a trained natural language model or rule set.

Input: Inquiry text string and location context.

Data processing: The server tokenizes the text into tokens, computes embeddings or feature vectors, and passes them through a trained classifier (for example, a multilayer neural network). The classifier outputs an intention label (such as “find_nearby_place” or “explain_area”) and a target category label (such as “food_service_facility”). The server also extracts constraints, such as “open now” or “for quick lunch,” by pattern matching and feature analysis.

Output: An intention context containing intention label, target category, and constraint set.
Step 8:

The server analyzes the emotional state of the user from the inquiry information.

The server executes an emotional state analysis module that uses a trained emotion classifier.

Input: Inquiry text string and optionally historical conversation records.

Data processing: The server computes linguistic features such as sentiment scores, specific keywords, and syntactic patterns, and passes embedding vectors through an emotion classification model (for example, a neural network or gradient-boosted tree). The model outputs an emotion label (such as “confused” or “in a hurry”) and a confidence score. The server stores these in an emotion context.

Output: An emotion context that represents the inferred emotional state and its confidence.
Step 9:

The server generates a prompt sentence to be supplied to the generative AI model.

The server calls a prompt generation module that applies template rules and context data.

Input: Intention context, location context, emotion context, and the original inquiry text.

Data processing: The server selects a prompt template based on the intention and target category, inserts the numeric coordinates and any region names, and appends constraints derived from the emotion context (for example, “explain in simple terms” or “keep the answer concise”). The server concatenates these elements into a single prompt sentence.

Output: A complete prompt sentence such as “The user is currently at latitude 35.6804 and longitude 139.7690. The user asked: ‘Where is the nearest cafe?’. Based on this location and question, identify the cafe that is closest to this location using reliable geographic information, and provide a concise explanation suitable for a map chat interface. Answer in one or two sentences.”
Step 10:

The server supplies the prompt sentence to the generative AI model and obtains response information.

The server invokes a generative AI interface module that communicates with an inference engine implementing a transformer-based neural language model.

Input: Prompt sentence text string.

Data processing: The server tokenizes the prompt sentence into subword units, packages the token sequence into a request, and transmits it to the inference engine. The inference engine executes attention and feed-forward computations over multiple layers using pre-trained weight matrices to generate a sequence of output tokens. The server receives the tokens, decodes them into natural language text, and optionally truncates or formats the text.

Output: Response information in natural language, for example “The nearest cafe to your current location is likely a small shop nearby that is popular for its freshly brewed coffee and relaxed atmosphere.”
Step 11:

The server extracts candidate facility names or keywords from the response information.

The server uses a lightweight natural language processing submodule or pattern matching to detect proper nouns and categories.

Input: Response information text.

Data processing: The server segments the text, identifies capitalized sequences or known category terms, and filters out stop words. The server constructs a candidate list of facility names or descriptive keywords.

Output: A candidate facility list that can be used to cross-check geographic search results.
Step 12:

The server queries an external geographic information database based on the position information and intention context.

The server constructs a geographic query specifying the normalized coordinates, the target category (for example, “food_service_facility”), and search parameters such as radius and maximum results.

Input: Location context, intention context, and optionally candidate facility list.

Data processing: The server calls a geographic database API or accesses a local spatial index. The geographic engine executes spatial range queries or nearest-neighbor searches using an index such as an R-tree. The server receives structured facility records including names, coordinates, addresses, and opening hours, and may filter or rank them using the candidate facility list and constraints.

Output: A sorted facility list that is consistent with both the geographic conditions and the AI-generated response content.
Step 13:

The server composes conversational explanation information by merging response information with facility information.

The server invokes a response composition module that integrates numeric and textual data.

Input: Response information text and sorted facility list.

Data processing: The server computes distances between the user position and each facility, selects one or more top facilities, and injects concrete attributes such as distance and opening hours into the explanation. The server may optionally send a secondary prompt sentence to the generative AI model to rephrase a summary based on a condensed description of the facility list. The modified or newly generated text is then stored as conversational explanation information.

Output: Conversational explanation information that explicitly refers to specific facilities and context, ready for presentation to the user.
Step 14:

The server generates map display data corresponding to the selected facilities and the user position.

The server encodes geographic coordinates, marker identifiers, and display parameters into a data structure suitable for rendering by the terminal.

Input: Location context and the selected facility list.

Data processing: The server calculates bounding boxes for map view, determines appropriate zoom levels, and assigns marker icons and labels. The server formats this information into a structured representation containing position pairs and display attributes.

Output: Map display data including user marker position, facility marker positions, and recommended map view configuration.
Step 15:

The server transmits the conversational explanation information and the map display data to the terminal.

The server packages the explanation text and map data into a structured response object and serializes it.

Input: Conversational explanation information and map display data.

Data processing: The server converts internal data structures to a format such as JSON, compresses the payload if necessary, and sends an HTTPS response to the terminal.

Output: A network response containing explanation text and map rendering parameters delivered to the terminal.
Step 16:

The terminal receives the response from the server and updates the user interface.

The terminal's network component parses the response and reconstructs the explanation text and map display data in memory.

Input: Structured response object from the server.

Data processing: The terminal decodes the structured format, extracts text and coordinate sets, and passes them to the user interface layer. The terminal constructs or updates chat message elements and map markers accordingly.

Output: Updated display content comprising a new chat message and revised map visuals.
Step 17:

The terminal renders the conversational explanation information and the map markers for the user.

The terminal draws the explanation text within the chat interface and invokes a map rendering software development kit to place markers at the user position and facility positions.

Input: Explanation text, user coordinates, facility coordinates, and display attributes.

Data processing: The terminal computes screen positions for markers using the map projection, adjusts zoom and pan settings, and applies style rules for markers and labels.

Output: A visual representation in which the user can see both the AI-generated explanation and geographical markers corresponding to recommended facilities or locations.
Step 18:

The user observes the displayed information and optionally issues a follow-up inquiry.

The user reads the conversational explanation and examines the markers on the map.

Input: Visual output presented on the terminal's display.

Data processing (by the user): The user interprets the information and may decide to ask a new question such as “Are there any options that are open late?” or “Please give me step-by-step walking directions.”

Output: New inquiry information entered into the terminal, which restarts the processing flow from the earlier steps.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional location-based information services, a computing system typically receives a user query as a simple keyword string and performs a static lookup in a geographic information database. Such systems often provide results in the form of map images, pins, and lists of facilities without taking into account nuances of the user's natural-language intent, contextual attributes (such as requested opening hours or special conditions), or the user's ability to interpret graphical information. As a result, the user must mentally translate between natural-language needs and low-level map artifacts, which imposes cognitive load and leads to inefficiencies and errors, particularly for users who have difficulty reading maps or interpreting visual layouts.

From a computational perspective, existing systems commonly separate natural-language understanding, geographic search, and response generation into loosely coupled modules with minimal feedback between them. User input is frequently reduced to rigid search parameters, and the underlying processing pipeline does not fully exploit advances in generative models capable of jointly handling unstructured text and structured geographic data. Moreover, conventional systems rarely analyze or adapt to the user's emotional state, and therefore cannot dynamically tailor prompts or responses to improve user engagement, clarity, and perceived responsiveness.

In addition, many systems treat generative models, if used at all, merely as front-end assistants that paraphrase answers, without integrating them deeply into the core control flow that links natural-language intent, geographic information retrieval, and conversational output. This leads to underutilization of the computational capabilities of generative models, unnecessary back-and-forth between separate components, and increased latency in generating contextually appropriate responses.

Accordingly, there is a need for a computer-implemented technique that improves the way a computing system processes natural-language, location-based queries by: (i) tightly integrating a generative model with structured geographic search; (ii) transforming heterogeneous data (user utterances, coordinates, facility metadata) into structured representations suitable for both deterministic search and generative reasoning; (iii) automatically generating and adjusting machine-readable prompt sentences to control the behavior of the generative model; and (iv) adapting conversational responses to a user's emotional state, while providing facility information in a purely conversational form without requiring interpretation of map imagery. Such an improvement would enhance the technical functioning of the system by optimizing the internal data flow, reducing cognitive and interactional overhead, and enabling more accurate and efficient satisfaction of user location-based inquiries.

The specific processing by the specific processing unit 290 of the data processing device 12 in Application Example 1 is realized by the following means.

The present invention provides a server comprising a processor configured to receive, from a user terminal, inquiry information expressed in natural language together with location information, to convert the inquiry information into text data, and to generate one or more prompt sentences that encode the inquiry information, the location information, and intermediate interpretation results as machine-readable control inputs for a generative information-processing model; to input the prompt sentences to the generative information-processing model so as to extract, from the inquiry information, at least a facility type and a requested attribute and to generate structured representations of user intent; to execute a geographic information providing function that performs a search of facility information for one or more facilities in a vicinity of a position indicated by the location information based on the extracted facility type, the geographic information providing function being configured to return facility information including identification information, position information, and operation time information of each facility; to normalize and store the facility information as structured data linked to the structured representations of user intent; to generate, based on the structured data and the inquiry information, further prompt sentences that condition the generative information-processing model to produce a response sentence in a conversational format describing the facility information without requiring display of a map image; to analyze an emotional state of a user on the basis of at least one of the inquiry information and the response sentence, and to dynamically adjust at least one of the prompt sentences and the response sentence in accordance with the analyzed emotional state; and to transmit the response sentence as chat-format text data to the user terminal for presentation to the user. This enables an improvement in the operation of the computer system by providing an integrated processing pipeline in which the generative information-processing model is programmatically controlled through structured prompt sentences, thereby enhancing the accuracy and efficiency of natural-language intent extraction, optimizing geographic information retrieval based on such intent, adaptively tailoring conversational responses to user emotion, and delivering location-based facility information in a form that does not rely on user interpretation of graphical map content.

The term “user terminal” refers to an information processing apparatus operated by a user, such as a portable electronic device or other computing device, that is configured to transmit inquiry information and location information to a server and to present chat-format responses received from the server.

The term “inquiry information” refers to information that represents a user's request or question, expressed in natural language, and input via the user terminal for the purpose of obtaining facility information or other location-based information.

The term “location information” refers to data indicating a geographic position associated with the user terminal or a user, including at least one of latitude information and longitude information, and optionally including altitude information, accuracy information, or time information.

The term “generative information-processing model” refers to a computational model for generating output data, such as text data, based on input data, the computational model being trained using machine learning techniques to perform at least one of natural-language understanding, natural-language generation, and reasoning over structured or unstructured information.

The term “prompt sentence” refers to a machine-readable control input including at least one natural-language expression or structured representation, which is provided to the generative information-processing model in order to specify a task, context, or desired style of an output generated by the generative information-processing model.

The term “facility type” refers to a classification category that identifies a kind of facility to which the inquiry information relates, such as a category of service-providing entity, commercial entity, or public entity.

The term “requested attribute” refers to a characteristic, condition, or property of a facility that is requested by a user in the inquiry information, including, for example, operation time, availability of services, or specific facility features.

The term “geographic information providing service” refers to a computer-implemented service configured to supply geographic-related data, including at least one of facility information, map information, route information, and position information, in response to search parameters or location information.

The term “facility information” refers to information relating to at least one facility, including at least one of identification information, position information, operation time information, category information, and other metadata describing the facility.

The term “identification information” refers to information that uniquely or distinctively identifies a facility within a geographic information providing service, such as an identifier, a name, or a label.

The term “position information” refers to data representing a geographic location of a facility, including, for example, coordinate information, address information, or other location descriptors.

The term “operation time information” refers to information indicating times or time ranges during which a facility is open, closed, or otherwise available to provide services.

The term “structured data” refers to data that is organized in a predefined schema or format, such as key-value pairs, records, or tables, enabling deterministic processing, searching, and transformation by a computing system.

The term “response sentence” refers to text data generated by the generative information-processing model or by another text-generation mechanism, which provides an answer or explanation to the inquiry information in a conversational format.

The term “conversational format” refers to a style or structure of information presentation that simulates a human-to-human dialogue, including at least one sentence or turn that appears as a message in a chat interface.

The term “chat-format text data” refers to text data formatted or structured for presentation as messages in a chat user interface, including metadata such as sender information, timestamps, or message types.

The term “emotion information” refers to information representing an estimated emotional state of a user, such as satisfaction, frustration, confusion, or preference, derived from analysis of the inquiry information, the response sentence, or interaction history.

The term “food and beverage providing facility” refers to a facility category that provides at least one of prepared food, drinks, or related services to users, such as a dining establishment or beverage establishment.

The term “graphical information” refers to information presented in a visual, non-textual form, including at least one of map images, icons, diagrams, or other graphical user interface elements.

The term “explanation data” refers to data generated for the purpose of describing a route or location, including at least direction information, distance information, and route outline information, in a form suitable for conversion into a textual explanation.

The term “direction information” refers to information indicating a direction or orientation from a reference position to a target position, such as cardinal directions, relative directions, or turn instructions.

The term “distance information” refers to information indicating a spatial separation between two positions, such as a length value represented in units of distance.

The term “route outline information” refers to information describing a path from a starting position to a destination position at a summarized level, including main waypoints, primary roads, or key turning points without requiring full graphical route depiction.

In one embodiment, a server cooperates with a terminal operated by a user to provide facility information in a conversational form without requiring the user to interpret a map image. The server includes at least one processor, a memory storing program instructions and data structures, and a communication interface connected to a communication network. The terminal includes at least one processor, a display module, a user input module, a position measurement module such as a global positioning module, and a communication module. The user operates the terminal to input an inquiry in natural language and to receive a chat-format response.

The terminal executes an application program that provides a chat-style user interface. The terminal uses a graphical user interface framework, such as a mobile user interface framework, to render a sequence of message bubbles corresponding to user utterances and server responses. The terminal captures user input via a touch screen or a keyboard and converts the input into a text string encoded in a character encoding such as UTF-8. The terminal temporarily stores the text string in a local memory and associates a timestamp and a session identifier with the text string.

The terminal uses an operating system location application programming interface, such as a fused location provider or a core location framework, in combination with a global positioning hardware module, to acquire position information including latitude and longitude of the terminal. The terminal may further obtain accuracy information and timestamp information from the location application programming interface. The terminal converts the position information into a numerical representation, for example floating-point numbers in a predetermined coordinate system, and constructs a data object that binds the text string representing inquiry information with the numerical position information and metadata such as language code and device identifier.

The terminal transmits the data object to the server via a secure communication protocol, such as a hypertext transfer protocol over transport layer security. The terminal uses a client-side networking library to serialize the data object into a message format and to send the message to a predetermined endpoint provided by the server. The terminal waits for a response and, upon receiving a response from the server, parses the response data and updates the chat-style user interface accordingly.

The server stores in the memory multiple software modules including a natural-language understanding module, a geographic search module, a response generation module, a user emotion analysis module, and a data management module. The server also stores parameters and configuration information for a generative AI model. The generative AI model in this embodiment is implemented using a neural network architecture configured for sequence-to-sequence processing, such as a transformer-based architecture having multiple encoder and decoder layers, attention mechanisms, and positional encoding. The model is trained in advance using supervised learning and, optionally, reinforcement learning from human feedback, on large corpora of natural-language data and structured facility data.

The server receives the message from the terminal through an application programming interface implemented by a web framework. The server validates the message format, extracts inquiry information, location information, and metadata, and stores the extracted data in a session data structure in the memory. The session data structure may be implemented as a record having fields corresponding to user identifier, session identifier, inquiry text, coordinates, and a conversation history buffer.

The server constructs a prompt sentence that encodes the inquiry information and the location information in a manner suitable for processing by the generative AI model. The server includes in the prompt sentence an instruction part specifying the task (for example, “Analyze the following user question to identify the type of facility and the requested attribute.”), a context part containing the user's inquiry and the coordinates (for example, “User question: ‘What are the opening hours of a cafénear here?’. User coordinates: latitude 35.6812, longitude 139.7671.”), and an output specification part defining the required output format (for example, “Output: facility type and requested attribute in plain text.”).

The server inputs the prompt sentence to the generative AI model by converting the prompt sentence into a sequence of tokens using a tokenizer associated with the model. The generative AI model applies an embedding layer to map the tokens into continuous feature vectors, applies positional encoding, and processes the vectors through multiple self-attention layers and feed-forward layers to generate contextualized features. The server configures the generative AI model with predetermined hyperparameters such as number of layers, hidden dimension size, attention head count, and dropout probability. During inference, the server does not update the model weights but applies a decoding procedure, such as greedy decoding or beam search, to generate an output sequence representing an interpretation of the user's inquiry.

The server parses the output sequence to extract a facility type and a requested attribute. The server may enforce a constrained output format by including in the prompt sentence explicit markers or tags that delimit the facility type and the requested attribute. In one example, the generative AI model outputs a text such as “facility type: cafe; requested attribute: opening hours”. The server then stores the extracted facility type and requested attribute in the session data structure. This process converts unstructured natural-language input into structured data suitable for precise geographic search, improving the accuracy of later processing and reducing the need for heuristic keyword matching.

The server uses the geographic search module to query a geographic information providing service. The server constructs a geographic search request including the latitude and longitude from the location information, a search radius, and the facility type as a keyword or category parameter. The server transmits the request to an external geographic information providing service application programming interface or to an internal geographic information database stored in association with the memory. The returned data includes, for each facility, identification information, position information, operation time information, and additional metadata such as category codes and user ratings. The server uses a deterministic ranking algorithm, for example based on distance from the user and priority rules, to select one or more facilities that best match the user's intent.

The server organizes the selected facility information as structured data. The server may use a standardized schema with fields such as facility_id, facility_name, address, latitude, longitude, opening_hours, distance_from_user, and attribute_flags. The server computes the distance_from_user field by applying a geographic distance formula, such as a haversine formula, to the user coordinates and facility coordinates. The server may also normalize operation time information into a consistent internal representation, such as an array of daily opening and closing time intervals represented in a standard time zone.

The server uses the response generation module to convert the structured facility information into a conversational response. The server constructs a second prompt sentence that includes the structured data and an instruction. An example of such a prompt sentence is: “User asked: ‘What are the opening hours of a cafe near here?’. The user is at latitude 35.6812 and longitude 139.7671. The nearest facility is: name=‘ABC Cafe’; address=‘1-2-3 Example Street’; distance=250 meters; opening hours=Monday-Thursday 08:00-20:00, Friday 08:00-22:00, Saturday 09:00-22:00, Sunday 09:00-18:00. Generate a concise, friendly response in English for a chat interface that answers the user's question.” The server again tokenizes this prompt sentence, feeds it to the generative AI model, and obtains a generated response sentence such as “The nearest cafe is ABC Cafe, about 250 meters from you. Its hours are 8:00-20:00 Monday-Thursday, 8:00-22:00 on Friday, 9:00-22:00 on Saturday, and 9:00-18:00 on Sunday.”

The server may alternatively use a template-based response generator when a more deterministic output is desired. In this variation, the server selects a response template based on the facility type and the requested attribute, and fills placeholders in the template with values from the structured data. The server can further refine the template output using the generative AI model by including both the template output and the structured data in the prompt sentence and asking the model to improve fluency while preserving factual content. The server includes an emotion analysis module that evaluates the emotional state of the user based on inquiry information and, optionally, prior conversation history. The server may, for example, construct a prompt sentence such as: “Analyze the emotion of the following user message: ‘I'm really tired and just want a quiet cafe near here.’. Output one of: {neutral, satisfied, frustrated, confused}.” The generative AI model outputs an estimated category, such as “frustrated”. The server then adjusts the style of subsequent prompt sentences, for instance by adding instructions like “Use an especially polite and reassuring tone.” This adjustment affects the generative model's decoding behavior and leads to responses that are better aligned with the user's emotional state.

The server obtains these technical effects through specific data structures and non-conventional processing flows. By encoding both raw user text and structured geographic data into prompt sentences, and using those prompt sentences as a control interface to the generative AI model, the server allows the same model to perform multiple roles: intent extraction, attribute identification, emotion classification, and natural-language response generation. This integration reduces the number of separate models and parsing components that must be loaded and executed, improves cache locality in the memory, and decreases end-to-end latency in producing a response. The server thereby improves the overall processing speed relative to systems that perform each of these tasks in isolated modules with repeated serialization and deserialization overhead.

The server also improves accuracy of facility selection and response generation because the generative AI model is not limited to shallow keyword matching. The model learns long-range dependencies and context during training, so it can correctly infer that “a place to get coffee and sit for a while” refers to a cafe even if the word “cafe” does not appear explicitly, and can map “open all night” to a “24 hour” attribute. The server exploits these capabilities by translating the user inquiry and structured facility information into carefully designed prompt sentences, enabling the generative AI model to operate as a context-sensitive decision engine rather than a simple text paraphraser.

The generative AI model in this embodiment is trained using gradient-based optimization such as stochastic gradient descent or an adaptive optimizer. The server or a training system uses a loss function appropriate for sequence prediction, such as a cross-entropy loss, computed between model outputs and reference sequences. The system may perform data augmentation by paraphrasing training sentences, shuffling structured attributes, and introducing synthetic noise to improve robustness. During training, the system updates model parameters (weights and biases) based on gradients computed by backpropagation. These detailed training procedures allow the model to acquire an internal representation of natural language and facility attributes that can be leveraged at inference time to achieve higher precision in intent extraction and response generation than rule-based systems.

In another embodiment, the server implements a hybrid architecture in which part of the interpretation is performed using deterministic rules and part using the generative AI model. For example, the server may use a rules engine to identify obvious facility types from a predefined dictionary and invoke the generative AI model only when the dictionary matching fails or when multiple ambiguous interpretations exist. This selective invocation reduces computational load, decreases inference latency, and preserves model capacity for difficult queries, thereby improving system efficiency.

In a further embodiment, the server supports multiple terminal types, including a smart phone, a tablet, and an in-vehicle infotainment system. The terminal in a vehicle environment may acquire location information not only from a global positioning module but also from a vehicle-internal position sensor network. The server may then adjust the search radius and facility ranking based on estimated vehicle speed and direction, which are additional features stored in the structured data. In this scenario, the server can generate prompt sentences that instruct the generative AI model to consider driving direction and traffic constraints when formulating a response, leading to technically improved route suggestions and reduced need for repeated user input.

The system described here does not merely automate human reasoning about maps. A human user could not practically replicate the sequence of tokenization, embedding, multi-layer attention, structured data mapping, and dynamic prompt adjustment at the speed and scale achieved by the server. The server uses specialized neural architectures, loss functions, and data structures to reorganize and compress heterogeneous data, and to perform computations over high-dimensional feature spaces. This processing pipeline constitutes an improvement in computer technology itself because it enhances the way the computer manages memory, schedules computational resources, and reduces network bandwidth usage through compact structured representations and targeted geographic queries.

The user benefits from these technical improvements in a concrete way. The user, for example, may input “Are there any 24 hour pharmacies near my current location?” The terminal acquires coordinates, the server extracts the facility type “pharmacy” and the requested attribute “24 hour operation,” the geographic search module retrieves only facilities satisfying those conditions, and the generative AI model produces a concise, accurate conversational answer. The server does not transmit large graphical map images in this case, thereby reducing communication load and power consumption on the terminal. The system provides a more efficient and precise location-based information service while leveraging specific computational techniques that improve the functioning of the server and the terminal. In still another embodiment, the server stores a conversation history and uses it as additional context in prompt sentences. For instance, after the user has asked “What are the opening hours of a cafe near here?” and received an answer, the user may then ask “Does that cafe have Wi-Fi?” The server includes the previously selected facility name and attributes in the new prompt sentence, such as: “The user previously asked about ABC Cafe near their current location. Now the user asks: ‘Does that cafe have Wi-Fi?’. Place details: ABC Cafe has free Wi-Fi according to stored metadata. Generate a short, friendly answer in English for a chat interface.” This context-aware prompting allows the generative AI model to reference earlier system state without re-executing full geographic searches, thereby improving response time and reducing redundant computation.

Through these various embodiments, the server, the terminal, and the user cooperate in a specific technical framework where generative AI models are controlled via prompt sentences that encode structured geographic and conversational data. This framework yields improved processing speed, higher accuracy of intent recognition and facility selection, reduced communication overhead, and enhanced usability for users who have difficulty interpreting graphical map information, thereby constituting a concrete improvement to computer technology rather than an abstract idea implemented on a generic computer.

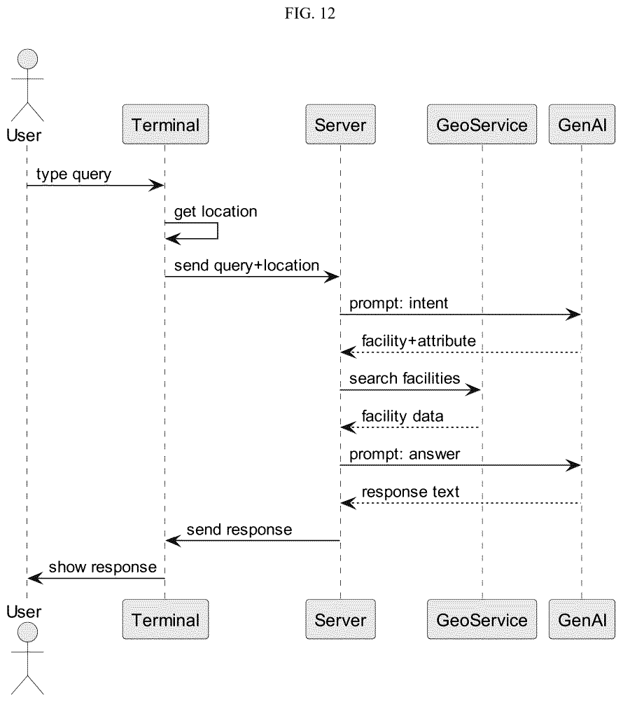

The following describes the processing flow using FIG. 12.
Step 1:

The user operates the terminal to launch a chat-based location service application and to input an inquiry in natural language. The user enters text such as “What are the opening hours of a cafe near here?” through a touch screen or keyboard and confirms the input. The input to this step is raw user interaction events (keystrokes, touch events), and the output is an encoded text string stored in the terminal's memory together with metadata such as a timestamp and a tentative session identifier.
Step 2:

The terminal acquires location information corresponding to the user's current position. The terminal invokes an operating system location API and a global positioning module to obtain latitude, longitude, and optional accuracy and time data. The input to this step is a location request triggered by the application, and the output is a location object containing numeric coordinate values. The terminal converts the raw location object into a normalized internal representation, for example floating-point latitude and longitude in a standard coordinate system, and binds this representation to the previously stored inquiry text.
Step 3:

The terminal constructs a request payload that combines the inquiry information and the location information. The terminal generates a data structure containing fields such as “query_text,” “latitude,” “longitude,” “language_code,” and “device_id.” The input to this step is the text string and the normalized coordinate values, and the output is a serialized message suitable for network transmission. The terminal performs data formatting and serialization operations, such as converting the internal data structure into a structured text message, and attaches necessary communication headers.
Step 4:

The terminal transmits the request payload to the server. The terminal uses a communication module to open a secure network connection and sends the serialized message to a predefined server endpoint. The input to this step is the serialized request payload, and the output is a network packet stream delivered to the server. The terminal performs protocol-level operations such as initiating a secure session, handling retries in case of transient errors, and queuing the request until a transmission slot is available.
Step 5:

The server receives the request payload and decodes it into internal data structures. The server uses a communication interface and a web application framework to accept the incoming network stream, validate headers, and parse the serialized body. The input to this step is the network packet stream containing the request payload, and the output is a session object in memory containing fields for inquiry text, coordinates, language information, and a conversation identifier. The server performs syntax checking, error handling, and logging of key values for monitoring.
Step 6:

The server constructs an interpretation prompt sentence for a generative AI model. The server reads the inquiry text and location data from the session object and generates a natural-language instruction that specifies an interpretation task. For example, the server generates: “Analyze the following user question to identify the type of facility and the requested attribute. User question: ‘What are the opening hours of a cafe near here?’. User coordinates: latitude 35.6812, longitude 139.7671. Output: facility type and requested attribute in plain text.” The input to this step is the inquiry text and metadata, and the output is a prompt sentence string prepared for tokenization. The server performs string concatenation, insertion of markers, and enforcement of a predetermined template to ensure consistent downstream processing.
Step 7:

The server tokenizes the prompt sentence and performs neural network inference using the generative AI model. The server applies a tokenizer to convert the prompt sentence into token identifiers, then applies an embedding layer, positional encoding, and multiple attention and feed-forward layers. The input to this step is the prompt sentence string, and the output is an output token sequence representing the model's interpretation. The server executes matrix multiplications, non-linear activations, and attention weight calculations according to the generative AI model's architecture, and uses a decoding algorithm such as greedy decoding to produce a deterministic textual output.
Step 8:

The server parses the model's output to extract a facility type and a requested attribute. The server receives a text sequence from the generative AI model, for example “facility type: cafe; requested attribute: opening hours,” and applies pattern matching or delimiter parsing to identify the segments corresponding to each field. The input to this step is the generated interpretation text, and the output is a pair of structured values stored in the session object: a facility type label and a requested attribute label. The server performs string scanning, splitting, trimming, and mapping from textual labels to internal category codes used by later modules.
Step 9:

The server executes a geographic search using the extracted facility type and the location information. The server constructs a query for a geographic information providing service, including the user's coordinates, a search radius, and the facility type mapped to search parameters. The input to this step is the facility type code and the coordinate values, and the output is a list of facility records returned by the geographic information service. The server performs parameter encoding, sends a search request via a network client, receives structured facility data, and stores the data in a temporary structure for ranking and filtering.
Step 10:

The server selects one or more relevant facilities and normalizes their information into a structured schema. The server processes the raw facility records, extracting identification data, position data, operation time data, and other metadata such as rating and category. The input to this step is the list of facility records from the geographic information service, and the output is a normalized data object containing one or more facility entries with standardized fields like name, address, coordinates, and opening hours. The server computes derived values such as distance from the user by applying a distance formula to coordinate pairs and may filter facilities based on the requested attribute.
Step 11:

The server constructs a response-generation prompt sentence for the generative AI model. The server reads the normalized facility data and the original inquiry text from the session object and builds a detailed instruction. For example, the server generates: “User asked: ‘What are the opening hours of a cafe near here?’. The user is at latitude 35.6812 and longitude 139.7671. The nearest facility is: name=‘ABC Cafe’; address=‘1-2-3 Example Street’; distance=250 meters; opening hours=Monday-Thursday 08:00-20:00, Friday 08:00-22:00, Saturday 09:00-22:00, Sunday 09:00-18:00. Generate a concise, friendly response in English for a chat interface that answers the user's question.” The input to this step is the normalized facility data and the inquiry text, and the output is a formatted prompt sentence string that encodes both structured and unstructured data.
Step 12:

The server generates a conversational response sentence by executing the generative AI model with the response-generation prompt. The server tokenizes the prompt, performs embedding and attention-based processing, and decodes an output sequence representing a natural-language answer, such as “The nearest cafe is ABC Cafe, about 250 meters from you. Its hours are 8:00-20:00 Monday-Thursday, 8:00-22:00 on Friday, 9:00-22:00 on Saturday, and 9:00-18:00 on Sunday.” The input to this step is the response-generation prompt sentence, and the output is a response sentence string. The server may apply post-processing, including trimming, basic grammar checks, and verification that required factual elements (name, hours) are present.
Step 13:

The server analyzes the user's emotional state and adjusts the response if necessary. The server constructs an emotion-analysis prompt based on the inquiry text and, optionally, conversation history, such as: “Analyze the emotion of the following user message: ‘I'm exhausted and need a quiet cafe near here as soon as possible.’ Output one of: {neutral, satisfied, frustrated, confused}.” The input to this step is at least the inquiry text and optional prior messages, and the output is an emotion label stored in the session object. The server may then generate a modified prompt or apply a transformation to the response sentence to align tone and level of detail with the detected emotion, for example adding reassurance or additional explanations.
Step 14:

The server packages the final response sentence into a response payload and transmits it to the terminal. The server assembles a data structure containing fields such as “message_type,” “response_text,” and optional facility metadata for display, and serializes this structure into a network message. The input to this step is the finalized response sentence and associated facility data, and the output is a network packet stream carrying the serialized response to the terminal. The server logs the transaction, updates conversation history, and releases temporary resources.
Step 15:

The terminal receives the response payload and updates the chat interface presented to the user. The terminal decodes the incoming network message, parses the response fields, and creates a new chat message element using the “response_text” content. The input to this step is the serialized response payload, and the output is a rendered chat bubble on the display showing the natural-language answer. The terminal may also display supplementary information such as facility name or distance in separate interface elements.
Step 16:

The user views the displayed response and may issue a follow-up inquiry. The user reads the conversational answer and, if additional information is needed, inputs a further message such as “Does that cafe have Wi-Fi?” using the same chat input interface. The input to this step is the current chat state on the terminal display, and the output is a new inquiry text string stored by the terminal and associated with the existing conversation session. The overall process then returns to earlier steps, with the terminal and server reusing the established data structures and conversation context to process the follow-up query efficiently.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In location-based information systems, a computer typically determines a user's position by relying on global navigation satellite data or manual map operations and then returns search results using fixed query templates. Conventional architectures suffer from several technical limitations. First, when satellite positioning is unavailable or inaccurate, such as in urban canyons or indoor environments, a processor running a location-based service cannot robustly determine the user's current position from sensor data alone. Second, even when an approximate position is available, a server generally applies simple keyword matching and static ranking logic to retrieve nearby content, which limits the server's ability to adapt computational behavior to nuanced user intent, context, or emotional state. Third, existing user interfaces often present map-based or text-based results in formats that are difficult for certain users to interpret, thereby increasing the number of user interactions and round-trip communications required for the user to obtain desired information.

From a computer-technology standpoint, these limitations manifest as inefficient use of processing resources on the server and the user terminal, increased network traffic due to repeated query/refinement cycles, and suboptimal utilization of machine-learned models, which are often only used as a post-processing layer for text generation rather than being integrated into the core control flow of image analysis, search parameter derivation, and response formatting. In particular, there is no coordinated mechanism by which a processor systematically combines image-derived position features, database search, and a generative AI model driven by structured prompt sentences to (i) determine a user's current position, (ii) derive machine-usable search conditions from natural-language input, (iii) generate ranked candidate information items, and (iv) transform such items into dynamically adjusted explanations responsive to an inferred user emotional state.

Accordingly, there is a need for an improved computer-implemented system and server-side processing method that tightly integrate image analysis, structured data retrieval, and generative AI model interaction through prompt sentences, so that the processor can more efficiently determine location, compute search parameters, and automatically adapt response content and representation. Such a system should reduce the computational overhead resulting from manual query reformulation, decrease error rates in position determination under weak satellite conditions, and improve the machine's ability to output content in formats that are easily understood even by users who have difficulty interpreting positional diagrams, thereby enhancing the overall technical performance of the information processing pipeline.

The specific processing by the specific processing unit 290 of the data processing device 12 in Example 2 is realized by the following means.

The present invention provides a server comprising a processor and a memory storing instructions that, when executed by the processor, cause the processor to receive imaging information acquired from a user terminal, execute image analysis processing on the imaging information to obtain object information and character information, and search an information storage device storing position information based on the object information and the character information to determine a current position of a user; to generate a first prompt sentence including the current position of the user and request information in natural language acquired from the user, input the first prompt sentence to a generative AI model, and extract intent information and search condition information corresponding to the request information; to search an external or internal information source based on the search condition information and acquire a plurality of candidate information items related to the current position of the user; to generate a second prompt sentence including the plurality of candidate information items and the request information, input the second prompt sentence to the generative AI model, and generate description information relating to the plurality of candidate information items; to output the description information and the plurality of candidate information items to the user terminal; and to input a third prompt sentence including utterance information in natural language acquired from the user to the generative AI model, extract an emotional state of the user, and adjust a representation format of the description information according to the emotional state. This enables the server to integrate image-based location determination, machine-interpreted search parameter generation, and adaptive response formatting into a unified processing pipeline, thereby improving the accuracy and robustness of position estimation under constrained sensing conditions, reducing the number of network round trips and computational cycles required to refine search results, and automatically producing user interface outputs that are more efficiently computed and more easily understood, including for users who have difficulty interpreting positional diagrams.

The term “user terminal” refers to an information processing apparatus operated by a user, including but not limited to a portable communication device, a handheld computing device, or any other electronic device having a display, an input interface, and a communication function for transmitting data to and receiving data from a server.

The term “server” refers to an information processing apparatus, or a group of interconnected information processing apparatuses, that provides computation, storage, and communication functions to process data received from one or more user terminals and to return processing results to the user terminals.

The term “processor” refers to one or more hardware processing units, such as a central processing unit or a graphics processing unit, that execute machine-readable instructions to perform information processing operations described in this specification.

The term “memory” refers to one or more non-transitory computer-readable storage media, including volatile or non-volatile storage, that store instructions and data for use by the processor.

The term “imaging information” refers to digital data representing at least one captured image of a scene surrounding the user terminal, the data being obtained by an image capturing device such as a camera and including information sufficient for image analysis processing.

The term “image analysis processing” refers to computational operations executed by the processor or a separate processing module to process imaging information and to derive higher-level semantic data, including but not limited to object detection, object recognition, feature extraction, and character recognition.

The term “object information” refers to information indicating one or more objects identified in the imaging information by the image analysis processing, including but not limited to object categories, labels, identifiers, confidence values, and positional attributes.

The term “character information” refers to information indicating one or more character strings detected in the imaging information by optical character recognition or equivalent processing, including textual content and optionally location or confidence data.

The term “information storage device” refers to any data storage system, including a database system or a file storage system, that stores structured or unstructured data such as position information, facility information, or other reference information accessible by the processor.

The term “position information” refers to information that indicates a geographic location, including but not limited to coordinates, address data, landmark identifiers, or any other data enabling identification of a physical position in real space.

The term “current position of a user” refers to a geographic location associated with the user terminal at a given time, the location being determined or estimated by the processor based on imaging information, object information, character information, and optionally other sensor or stored data.

The term “natural language” refers to a human language used for everyday communication, including but not limited to spoken or written sentences, phrases, or words that are not restricted to a predefined command syntax.

The term “request information” refers to information indicating a user's demand, preference, question, or instruction, expressed in natural language and obtained from input operations at the user terminal.

The term “utterance information” refers to natural language content generated by or on behalf of the user, including spoken or written expressions obtained through text input, voice input, or any other modality that produces natural language data.

The term “prompt sentence” refers to a text sequence, optionally combined with structured data, that is constructed by the processor and provided as input to a generative AI model in order to cause the model to perform a specified processing task or to generate a desired output.

The term “generative AI model” refers to a machine-learned information processing model, such as a neural network including a large language model or a multimodal model, that generates output data including text or other content in response to an input prompt sentence.

The term “intent information” refers to information derived from request information by the processor or the generative AI model that represents an interpreted purpose, goal, or underlying meaning of the user's request in a form suitable for machine processing.

The term “search condition information” refers to information derived from intent information or request information that specifies parameters for searching an information source, including but not limited to categories, ranges, constraints, or filter conditions.

The term “external information source” refers to an information providing system, accessible via a communication network and operated separately from the server, that supplies data such as position information, facility information, or other resource information in response to search queries.

The term “internal information source” refers to an information storage system under the control of the server, such as a local database or index, that stores data including position information, facility information, or other resource information for retrieval by the processor.

The term “candidate information item” refers to a unit of information obtained from an external or internal information source as a potential response element to the user's request, such as an item representing a specific place, facility, service, or resource.

The term “description information” refers to information generated by the processor or the generative AI model that explains, summarizes, or comments on one or more candidate information items in a form suitable for presentation to the user.

The term “facility information storage device” refers to an information storage device that stores data relating to facilities, including but not limited to service providing facilities for food and drink, and that can be searched by the processor using search condition information.

The term “service providing facility for food and drink” refers to a facility at which a user can obtain food or beverages, including but not limited to restaurants, cafes, bars, or similar establishments.

The term “positional diagram information” refers to information representing spatial relationships between locations, including map data or diagrammatic representations, that visually indicate positions or routes.

The term “route guidance information” refers to information that describes a path or sequence of steps for moving from one location to another, including textual instructions, schematic representations, or other forms that assist a user in navigation.

The term “emotional state” refers to a condition or attitude of the user inferred from utterance information, such as satisfaction, dissatisfaction, anxiety, or confidence, which is estimated by the generative AI model or by further processing of its output.

The term “representation format” refers to a style, structure, or level of detail of description information, including choice of vocabulary, length, emphasis, or layout, which can be adjusted by the processor based on the emotional state or other context.

In one embodiment, a server, a terminal, and a user cooperate to implement the claimed system. The server includes at least one processor and at least one memory. The terminal includes at least one processor, at least one memory, an image capturing device, a display, and a communication interface. The user operates the terminal to provide imaging information and natural language input. The server executes instructions stored in the memory to perform image analysis, database search, and interaction with a generative AI model based on prompt sentences.

The server uses general-purpose computing hardware such as a central processing unit and, optionally, an accelerator such as a graphics processing unit or a tensor processing unit. The server uses a general-purpose operating system and a server-side framework such as a web application framework to receive and respond to network requests. The server uses a database management system, such as a relational database system or a search engine, to store position information, facility information, and related metadata. The server further uses a trained generative AI model implemented on a neural-network inference engine, such as a transformer-based language model, to interpret prompt sentences and generate outputs.

The terminal uses an image capturing device such as a solid-state image sensor integrated in a camera module to acquire imaging information of an environment surrounding the user. The terminal uses a communication module such as a cellular modem or a wireless local area network interface to transmit the imaging information and natural language input to the server. The terminal uses a display controller to present position information, candidate information items, and description information to the user.

The server stores instructions in the memory that cause the processor to perform image analysis processing. In one embodiment, the server uses image analysis software that incorporates a deep neural network for image recognition. The server may use a convolutional neural network trained on a large corpus of images containing landmarks, buildings, signs, and other objects. The server may further use an optical character recognition engine to extract character information from the imaging information. The server may implement image analysis using frameworks such as a generic deep learning framework and an OCR library.

The server uses the image analysis processing to convert raw pixel data into structured object information and character information. The server represents the object information as a structured record including object identifiers, category labels, confidence scores, and bounding regions. The server represents the character information as a structured record including recognized strings, confidence scores, and positional coordinates in the image. The server stores these records in an intermediate data structure in the memory.

The server uses the object information and the character information to search an information storage device that stores position information associated with landmarks, facilities, and other geographic entities. The server organizes the position information in a database table or index. The server associates each record with a geographic coordinate, a normalized name, one or more aliases, and, optionally, one or more feature vectors derived from training data.

The server uses string matching algorithms, including exact matching, approximate matching, and full-text search, to compare character information against stored names and aliases. The server uses feature-based comparison to compare object labels or image-derived embeddings with stored feature vectors. The server computes similarity scores based on these comparisons and selects one or more candidate positions. The server determines a current position of the user by choosing the candidate position having a similarity score above a threshold or by combining multiple scores using a weighted aggregation. The server may further refine the determination using approximate location information transmitted from the terminal, such as coarse location or network-based location, by applying geometric constraints.

The server generates a prompt sentence including the current position of the user and request information in natural language acquired from the user. The server constructs the prompt sentence as a concatenation of textual segments: a context segment describing the current position, a user query segment containing the request information, and an instruction segment specifying the output format or task for the generative AI model. For example, the server may generate a prompt sentence such as:

“The user is currently near a large steel tower in the central area of a city, located at a latitude of 35.6586 and a longitude of 139.7454. The user has requested: ‘Please tell me some good cafés nearby.’ Extract the user's intent and convert it into search parameters for a places search. Respond in the form: category, radius in meters, minimum rating, and optional filters.”

The server inputs this prompt sentence to a generative AI model. In one embodiment, the generative AI model is a transformer-based language model having multiple attention layers, feed-forward layers, and layer normalization. The server stores the model parameters, such as weight matrices and bias vectors, in a model storage area on a storage medium, and loads them into memory for inference. The server pre-trains the model on a large text corpus and optionally fine-tunes the model on a domain-specific dataset containing examples of location-based queries, facility descriptions, and user intents.

The server configures the generative AI model to perform forward propagation through a stack of self-attention and feed-forward sublayers. The server represents the prompt sentence as a sequence of token identifiers and uses an embedding layer to map the tokens to continuous vectors. The server applies positional encodings, multi-head self-attention, and non-linear activation functions such as rectified linear units or Gaussian error linear units. The server computes output token distributions using a softmax layer. The server decodes the output token probabilities to generate a textual representation of intent information and search condition information.

The server may use a supervised learning process to train or fine-tune the generative AI model. The server defines a loss function, such as a cross-entropy loss between predicted token distributions and ground-truth token sequences. The server updates the model parameters using an optimization algorithm such as stochastic gradient descent with momentum or an adaptive optimizer. The server may perform data augmentation by paraphrasing request sentences, sampling different instruction phrases, and varying contextual details to improve the robustness of the model.

The server parses the output of the generative AI model to extract machine-readable intent information and search condition information. The server may instruct the generative AI model to output structured text containing labels such as “category=”, “radius=”, or “filters=”. The server parses these labels using string-processing functions to obtain discrete parameters. The server then searches an external or internal information source using these parameters. The server may issue queries to a points-of-interest database or an external service API by specifying a category, a search radius in meters, a minimum rating, and a set of filters, such as “quiet”, “has Wi-Fi”, or “open now”. The server sorts the retrieved entities based on computed scores that may combine rating, distance, and relevance to the user's request.

The server receives a plurality of candidate information items as the result of such search. The server stores each candidate information item as a record including attributes such as name, address, geographic coordinate, rating, distance from the current position, and opening hours. The server may assign a candidate score to each record based on a weighted sum of normalized rating and inverse distance. The server selects a subset of candidate information items according to the candidate scores, such as the top N items where N is a configurable parameter.

The server generates another prompt sentence including the plurality of candidate information items and the request information. The server constructs this prompt sentence so that the generative AI model produces description information suitable for the user. For example, the server may generate a prompt sentence such as:

“The user is near a central station in a large city. The user asked: ‘Please tell me some good cafes nearby.’ You have the following candidate cafes: (1) Cafe Alpha: rating 4.5, distance 300 meters; (2) Cafe Beta: rating 4.3, distance 450 meters; (3) Cafe Gamma: rating 4.2, distance 600 meters. Write a short recommendation in English, listing these cafes in a numbered list. For each cafe, include the name, walking time from the user's location, and one short comment.”

The server inputs this prompt sentence to the generative AI model and receives description information generated based on the candidate information items and the request information.

The server does not simply restate database content; instead, the server uses the generative AI model to compute linguistic transformations that adapt the level of detail, ordering, and style.

The server outputs the description information together with the plurality of candidate information items to the terminal, which displays them using a graphical user interface.

The server also generates a prompt sentence including utterance information in natural language acquired from the user. The server uses this prompt sentence to estimate an emotional state of the user. For example, the server may generate a prompt sentence such as:

“The user said: ‘I am confused, I still don't understand where I should go.’ Classify the user's emotional state as one of: calm, frustrated, anxious, or satisfied. Then explain in one short sentence how the explanation style should be adapted for this user.”

The server inputs this prompt sentence to the generative AI model and receives a classification and a recommendation for the representation format. The server maps the emotional state to specific representation parameters, such as using shorter sentences, adding more stepwise instructions, or avoiding technical terms. The server applies these parameters when issuing subsequent prompt sentences for description generation. The server thereby adjusts the representation format of the description information according to the emotional state.

The server, in another embodiment, addresses situations where the user has difficulty interpreting positional diagram information. The server uses the generative AI model to transform position information into simplified or narrative descriptions. The server may generate a prompt sentence such as:

“The user is currently at the north exit of a busy station. The destination café is 400 meters to the south on a main street. Describe a simple walking route in English, with no map references, using short sentences and clear landmarks.”

The server inputs this prompt sentence to the generative AI model and receives route guidance information that explains how to move from the current position to the destination using step-by-step instructions. The server outputs this information to the terminal, which may display it as numbered text steps or read it aloud.

This architecture provides technical improvements over conventional systems. The server uses image analysis processing in combination with a generative AI model to determine the current position without depending solely on satellite-based location. This improves accuracy and robustness in urban environments and indoor locations. The server reduces the number of user interactions by automatically converting natural language requests into structured search condition information, which reduces network round trips and computation time for successive searches. The server further optimizes communication load by sending compact structured parameters and by using prompt sentences that cause the generative AI model to produce appropriately detailed output in a single inference call.

The server improves calculation efficiency by using a modular data flow: first, image-based feature extraction; second, database matching; third, generative AI-based interpretation of intent; and fourth, database-based retrieval followed by generative AI-based explanation. This pipeline allows the server to avoid repeatedly executing heavy image analysis or external searches. For example, once the server has determined the current position and extracted stable features, the server can reuse those features across multiple requests.

The server improves data management by storing object information, character information, and position information in normalized structures. The server can index these structures for fast lookup, segment caching, and reuse of previous computation results. When similar images are uploaded, the server can compare feature vectors against existing records and avoid redundant processing. This yields lower latency and reduced resource consumption. The generative AI model, as implemented by the server, does not simply imitate human reasoning but applies a parameterized inference process optimized for multi-step prompt workflows. The server uses non-conventional prompt designs that interleave machine-readable markers with natural language. By doing so, the server causes the generative AI model to generate outputs that are directly parseable by the processor without separate natural language understanding modules. This reduces complexity and error sources present in conventional modular systems.

The server uses specific rules for prompt construction and parsing that differ from ordinary conversational usage. For example, the server may instruct the generative AI model to always output a fixed sequence of labels followed by values. The server enforces this structure by verifying the presence of labels and discarding incomplete outputs. This rule-based interaction between the processor and the generative AI model constitutes a specialized protocol that improves reliability and reduces the need for human supervision.

The learning process of the generative AI model also contributes to technical effects. The server may augment the training dataset with synthetic examples where image-derived context and database structures are explicitly encoded into prompts. The server may use a specialized loss function that penalizes deviations from required output formats, such as missing fields or malformed lists. This biases the generative AI model toward producing outputs that can be efficiently processed and used to control subsequent computational steps. As a result, the server can maintain higher throughput and lower error rates when handling concurrent user requests.

In another embodiment, the server uses multiple generative AI models. For example, the server may use a first generative AI model specialized in extracting search condition information from user requests and a second generative AI model specialized in generating user-facing description information. The server routes prompt sentences to the appropriate model based on task type. The server may share a portion of parameters between models or maintain independent parameter sets. This division of labor provides additional technical benefits by allowing model architectures and parameter sizes to be tuned for specific processing tasks, thereby reducing average computation time per request.

In yet another embodiment, the server executes the generative AI model on hardware-accelerated inference engines configured with low-precision arithmetic, such as reduced-precision floating point. The server quantizes model parameters and intermediate activations to reduce memory bandwidth and improve inference speed. The server maintains accuracy by calibrating quantization ranges using a calibration dataset. This configuration enables real-time processing of user requests in mobile network environments and reduces server-side power consumption.

The terminal may, in some embodiments, perform a portion of the processing. For example, the terminal may perform compression of imaging information, pre-filtering of images, or preliminary generation of prompt sentences based on cached templates. However, the server remains responsible for the core steps of image analysis, position determination, search parameter derivation, and AI-based explanation. The distribution of processing between the terminal and the server can be adjusted according to network conditions and hardware capabilities.

The system, through these concrete architectures and methods, improves computer technology itself. The server exploits the combined operation of image analysis modules, structured databases, and generative AI models with carefully constructed prompt sentences to achieve faster and more accurate position determination, more efficient search parameter computation, and adaptive presentation optimized for user understanding. The system reduces computational load, minimizes network traffic, and lowers error rates compared with conventional systems that treat these functions as separate, loosely coupled modules or rely on static template-based logic.

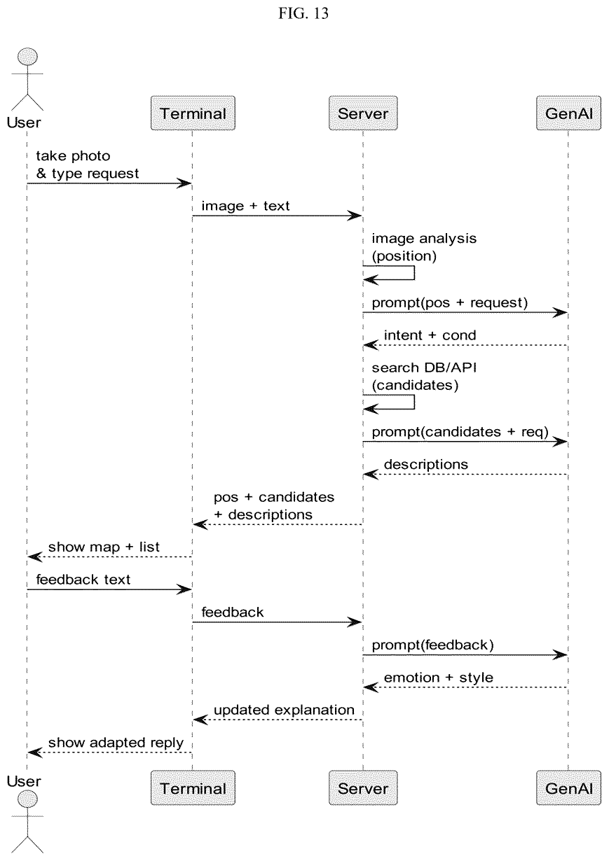

The following describes the processing flow using FIG. 13.
Step 1:

The user operates the terminal to capture imaging information of the surroundings. The terminal activates a camera module, converts light from a scene into pixel data through an image sensor, and stores the captured image as a digital file in local memory. The input of this step is a real-world scene, and the output of this step is imaging information in a structured file format, such as a compressed color image.
Step 2:

The user operates the terminal to select the captured image and to request position determination. The terminal reads the selected image file from local storage, wraps the image bytes and optional metadata into a network message, and sends the message to the server through a communication interface. The input of this step is the imaging information and user instruction, and the output of this step is a network request packet containing the imaging information and metadata such as a timestamp and a coarse location estimate.
Step 3:

The server receives the network request from the terminal. The server parses the request headers and body, validates the image format and size, and stores the raw image bytes and metadata in a storage device. The input of this step is the network packet containing the imaging information and metadata, and the output of this step is a stored image record and a corresponding internal identifier used for subsequent processing.
Step 4:

The server executes image analysis processing on the stored image. The server loads the image bytes into memory, resizes and normalizes the pixel values, and inputs the processed image tensor into an image recognition neural network. The server uses a convolutional neural network to compute feature maps, applies non-linear activations and pooling operations, and outputs probability distributions over object classes and landmark categories. In parallel, the server applies an optical character recognition algorithm to detect and recognize character regions in the image. The input of this step is the stored image record, and the output of this step is structured object information and character information, each including identifiers, confidence scores, and positional coordinates in the image.
Step 5:

The server determines a current position of the user by matching the object information and character information against position information stored in an information storage device. The server constructs search keys from recognized object labels and character strings, normalizes the strings (for example, by lowercasing and removing punctuation), and issues database queries that retrieve candidate geographic records. The server computes similarity scores using text matching algorithms and, when available, compares embedding vectors derived from the image against stored landmark feature vectors. The server aggregates scores from multiple features and selects a geographic record whose aggregated score exceeds a threshold. The input of this step is the object information and character information, and the output of this step is a current position record including coordinates, an address, and an associated landmark identifier.
Step 6:

The user enters request information in natural language on the terminal. The terminal displays an input interface, accepts character sequences from a keyboard or voice recognition module, and packages the resulting natural language text together with the current position record previously received from the server. The terminal sends this combined data to the server in a request message. The input of this step is the user's natural language text and the displayed current position, and the output of this step is a network message containing request information and position information.
Step 7:

The server constructs a first prompt sentence for a generative AI model using the current position record and the request information. The server concatenates a description of the current position, the verbatim user request, and explicit instructions on how to format the output into a single text string. The server tokenizes this text string and sends the token sequence to a transformer-based language model. The model performs matrix multiplications and attention operations to compute contextual embeddings and to generate output tokens that represent intent information and search condition information. The input of this step is the current position record and the request information, and the output of this step is machine-readable intent information and search condition information extracted from the generative AI model output.
Step 8:

The server uses the search condition information to query external or internal information sources for relevant candidates. The server translates the search condition information into concrete query parameters, such as category type, search radius, minimum rating, and filter flags, and issues these parameters to a place-information database or an external service through an application programming interface. The server receives raw result records, computes a ranking score for each record using a scoring function that combines distance and rating, and selects a subset of top-ranked candidates. The input of this step is the search condition information and the current position record, and the output of this step is a plurality of candidate information items that satisfy the search conditions.
Step 9:

The server generates a second prompt sentence that includes the plurality of candidate information items and the original request information. The server formats each candidate information item as a concise textual description, aggregates them into a list, and adds instructions that specify the desired explanation style and structure. The server tokenizes this second prompt sentence and inputs the tokens to the generative AI model. The model computes a sequence of output tokens that form descriptive sentences for the candidate information items. The input of this step is the candidate information items and the request information, and the output of this step is description information that explains or recommends the candidate information items in natural language.
Step 10:

The server sends the candidate information items and the description information to the terminal. The server assembles a response message that includes structured data for the candidates and a text field containing the generated description. The terminal receives the message, parses the structured data, and renders a graphical list or card layout on the display. The terminal associates each candidate with a user-selectable element that can show additional details or start navigation. The input of this step is the candidate information items and the description information, and the output of this step is a displayed interface that presents the candidates and the explanation to the user.

Step 11:

The user optionally provides follow-up utterance information in natural language, such as expressing confusion or satisfaction with the presented information. The terminal captures this follow-up text, attaches context identifiers such as the last displayed candidate list, and transmits the utterance information to the server. The input of this step is the user's follow-up text and the displayed context, and the output of this step is a request message containing utterance information and context identifiers.
Step 12:

The server constructs a third prompt sentence that includes the utterance information and context information, such as the type of previous response. The server instructs the generative AI model, through the prompt sentence, to classify the emotional state of the user and to propose an adaptation strategy for future responses. The generative AI model processes the tokenized third prompt sentence and outputs text that includes a labeled emotion category and a description of the recommended representation adjustments. The server parses this output to extract a discrete emotional state and associated presentation parameters. The input of this step is the utterance information and the context information, and the output of this step is an estimated emotional state and one or more representation parameters.
Step 13:

The server applies the representation parameters derived from the emotional state to subsequent description generation. The server modifies future prompt sentences by specifying constraints such as shorter sentences, additional step-by-step guidance, or simplified vocabulary. The server thus alters the generative AI model's behavior in a systematic way, resulting in new description information that is better matched to the user's inferred emotional state. The input of this step is the emotional state and representation parameters, and the output of this step is adapted prompt sentences and, in turn, adapted description information that the server provides to the terminal for display to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented information provision and navigation systems typically rely on fixed rule-based logic, explicit location signals (for example, satellite-based positioning), and static dialog flows. Such systems suffer from several technical limitations in terms of how they process input data, manage interaction state, and generate outputs.
First, traditional systems generally treat user input as a single, flat query, and do not dynamically identify missing constraint conditions nor automatically generate follow-up questions at the system level. As a result, the processing pipeline in the processor cannot iteratively refine an internal representation of user intent and constraints, which leads to inefficient resource usage and increased network calls, as the system may repeatedly issue broad external searches and perform unnecessary computations.
Second, when satellite-based positioning signals are unavailable or degraded, such as in tunnels, indoor environments, or dense urban areas, conventional systems are unable to robustly determine the user's current position. These systems generally lack a technical mechanism for combining image-based feature extraction with higher-level inference in order to estimate location and integrate that estimate into subsequent computational queries. This results in failure to provide position-dependent services, degraded route computation, and suboptimal use of image analysis and mapping resources within the computer system.
Third, existing dialog systems typically process user emotion, if at all, as an auxiliary label that does not structurally influence how internal queries are formed, how candidate options are selected, or how responses are generated. The processing architecture therefore treats emotion as an afterthought, rather than as a parameter that systematically modulates data retrieval, option ranking, and response generation. This leads to a rigid, one-size-fits-all dialog that does not adapt the computational behavior of the system to different interaction contexts.
Fourth, many users, including users who are weak at interpreting map representations, receive navigation instructions primarily in the form of coordinate-based map displays or generic route lists. Conventional processors are not configured to algorithmically transform coordinate-level route data into multiple alternative guidance formats such as landmark-based descriptions or step-by-step action instructions, nor to select among these formats based on an inferred user state. Consequently, internal route data structures are not fully exploited, and the user interface logic remains constrained by a single modality, which diminishes the overall effectiveness and robustness of the computer system.

In short, there is a need for an improved computer-implemented system in which a processor cooperatively uses a generative artificial intelligence model, prompt sentences, multimodal analysis resources, and external information resources to (i) iteratively refine intent and constraints, (ii) robustly estimate user location even under poor explicit positioning conditions, (iii) incorporate emotion into the formation of internal queries and response generation, and (iv) transform structured geographic information into multiple, dynamically selected guidance formats. Such improvements should enhance the technical performance of the system in terms of flexibility, robustness of location estimation, efficiency of external resource usage, and adaptability of dialog management.

The specific processing by the specific processing unit 290 of the data processing device 12 in Application Example 2 is realized by the following means.

The present invention provides a server comprising a processor configured to receive and preprocess user linguistic information and user non-linguistic information, input a prompt sentence to a generative artificial intelligence model on the basis of the preprocessed linguistic information, and extract a user intent and constraint conditions and identify missing constraint conditions; input a prompt sentence to the generative artificial intelligence model in accordance with the missing constraint conditions, and generate additional input request sentences to be presented to the user; generate internal query information by integrating current position information of the user, the extracted intent, the constraint conditions, and an emotion state of the user on the basis of additional input from the user; access a location-related information processing resource or an external information providing resource on the basis of the internal query information, acquire candidate location information, and extract, by computation, a plurality of options that match the user intent and the constraint conditions; use an emotion analysis resource on the basis of the user linguistic information and user facial image information, and identify the emotion state of the user; input a prompt sentence to the generative artificial intelligence model on the basis of the emotion state, the plurality of options, and the current position information, generate a response sentence in which presentation contents of the plurality of options and an expression format of a dialog sentence are adjusted, and generate presentation information to be presented to the user; and, when the current position information of the user is difficult to acquire by a positioning resource, input a surrounding image acquired from a user terminal to an image analysis resource, estimate the current position of the user on the basis of extracted feature information, and reflect the estimated current position in the internal query information. This enables the computer system to iteratively refine an internal representation of user intent and constraints via the generative artificial intelligence model and prompt sentences, to maintain robust and continuous location-dependent processing even when explicit positioning signals are degraded by incorporating image-based position estimation into the query pipeline, to structurally incorporate emotion analysis into option selection and response generation so that dialog behavior and resource usage are adaptively controlled at the processor level, and to transform structured geographic and option data into dynamically adjusted, user-appropriate guidance and presentation formats, thereby improving the overall technical performance, flexibility, and robustness of the server-based information provision and navigation system.

The term “processor” refers to a hardware or virtual computation unit, such as a central processing unit or a processing core in a server system, that executes machine-readable instructions to perform data processing, control flows, and communication with other hardware and software resources.

The term “user linguistic information” refers to information expressed by a user in a natural language form, including text input, speech-to-text converted utterances, and other language-based content that can be parsed and analyzed as sequences of words or symbols.

The term “user non-linguistic information” refers to information related to the user that is not primarily expressed as natural language text, including image data, audio data other than transcribed speech, sensor readings, location signals, and other contextual data associated with user behavior or environment.

The term “preprocess” refers to performing one or more operations on raw input data to transform, normalize, or annotate the data for subsequent processing, such operations including tokenization, normalization, filtering, feature extraction, encoding, or formatting.

The term “prompt sentence” refers to a text instruction or query provided as input to a generative artificial intelligence model, the text instruction specifying a task, context, constraint, or desired output format to guide the behavior of the model.

The term “generative artificial intelligence model” refers to a parameterized computational model trained on data to generate outputs such as text or other structured information in response to input data and prompt sentences, the model including, for example, a neural network-based language model.

The term “user intent” refers to a structured representation of a purpose, goal, or task that a user wishes a system to perform, as inferred from user linguistic information and other context, such as a desire to find a location, request information, or obtain a service.

The term “constraint conditions” refers to parameters or limits associated with a user intent, including preferences, thresholds, ranges, or context-based restrictions, such as budget limits, distance limits, time constraints, or content preferences.

The term “missing constraint conditions” refers to constraint conditions that are relevant to a user intent but are not yet explicitly specified or inferred from the currently available user information, and which the system identifies as incomplete or unknown.

The term “additional input request sentence” refers to a natural language sentence generated by the system to request further information from the user, such as clarification questions or prompts aimed at resolving missing constraint conditions.

The term “internal query information” refers to a structured data object that aggregates and encodes user intent, constraint conditions, current position information, emotion state, and other context, and that is used by the processor for searching, filtering, and generating options.

The term “current position information” refers to information indicating a spatial location associated with the user, including geographic coordinates, relative positions, or estimated positions derived from positioning resources or image analysis.

The term “emotion state” refers to a classification or representation of a user's emotional condition, such as joy, frustration, fatigue, or neutrality, determined by processing user linguistic information, facial image information, or other signals using emotion analysis techniques.

The term “location-related information processing resource” refers to a computational or service resource that processes data relating to spatial position or geography, such as a mapping service, route computation service, or location database.

The term “external information providing resource” refers to a computational or service resource that is external to the processor and that provides information in response to queries, such as a remote database, web service, or application programming interface.

The term “candidate location information” refers to data representing one or more potential locations or points of interest obtained from location-related or external information resources, before final selection or filtering based on user intent and constraint conditions.

The term “option” refers to an item of information representing a selectable alternative provided to the user, such as a candidate facility, route, action plan, or other choice derived from candidate location information and internal query information.

The term “emotion analysis resource” refers to a computational component or service that processes user linguistic information, facial image information, or other data to determine or estimate the user's emotion state.

The term “facial image information” refers to digital image data that includes at least a portion of a user's face or facial region, and that is usable for detecting expressions or other visual features associated with emotion.

The term “response sentence” refers to a natural language sentence generated by the system for presentation to the user, the sentence including system outputs such as explanations, guidance, or feedback.

The term “presentation information” refers to data prepared for display or rendering to the user, including response sentences, option lists, guidance messages, and associated metadata for controlling presentation layout or modality.

The term “positioning resource” refers to a hardware or software component that provides position information, such as a satellite positioning receiver, a network-based positioning module, or other location determination mechanism.

The term “surrounding image” refers to an image of an environment around the user, captured by an imaging device, and including scenery, structures, or landmarks that can be used for estimating the user's location.

The term “image analysis resource” refers to a computational component or service that processes image data to detect or extract features, objects, landmarks, or other visual information relevant to location estimation or context understanding.

The term “feature information” refers to data representing salient characteristics extracted from input data, such as visual features detected in an image, linguistic features detected in text, or statistical descriptors used for further computation.

The term “food and beverage providing facility” refers to a location or establishment that offers prepared food or drinks to users, such as restaurants, cafes, or similar service venues.

The term “food preference” refers to a constraint condition associated with a user's desired type, style, flavor, or characteristic of food or drink, including preferences for cuisine type, spiciness, ingredients, or dietary restrictions.

The term “budget condition” refers to a constraint condition specifying a monetary range or expenditure limit associated with a user's request, such as a maximum cost per item or per user.

The term “priority of the options” refers to an ordering, ranking, or scoring assigned to options based on one or more criteria, such as relevance to the internal query information, proximity, rating, or emotion state of the user.

The term “tone of explanation sentences” refers to stylistic and affective characteristics of generated sentences, including politeness level, formality, friendliness, empathy, or intensity, adjusted according to the user's emotion state or context.

The term “position display information” refers to visual or symbolic information that represents spatial positions, such as map views, coordinate indicators, or other graphical location representations.

The term “route description sentence” refers to a natural language sentence that describes a path or route between locations in an abstracted or human-readable form, rather than as raw coordinate sequences.

The term “landmark” refers to a recognizable object or feature in the physical environment, such as a building, sign, intersection, or natural feature, that can be used as a reference point in guidance or location estimation.

The term “guidance sentence based on landmarks” refers to a natural language sentence that instructs a user how to move or navigate by referencing landmarks, such as indicating directions using visible or known environmental features.

The term “step-by-step action instruction sentence” refers to a sentence that specifies a discrete user action within a sequence of actions along a route, such as “walk straight for a certain distance” or “turn left at the next intersection.”

The term “expression of the guidance” refers to the wording, style, and structure used to present navigational or instructional information to the user, including choice of vocabulary and sentence patterns.

The term “level of detail of the guidance” refers to the granularity of information provided in navigation or instructions, such as how many steps are described, how precise distances are, or how many intermediate landmarks are mentioned.

In one embodiment, a server, a terminal, and a user cooperate to implement the claimed system. The server is implemented as one or more physical machines in a data center, each machine including a processor, a memory, a non-volatile storage device, a network interface, and optionally a dedicated accelerator such as a graphics processing device or a tensor processing device. The terminal is implemented as a mobile communication device, an in-vehicle information device, or another computing device including a processor, a memory, a display, an input interface, a camera, a microphone, a positioning module, and a wireless communication interface.

The server executes server-side application software on an operating system such as a general-purpose server operating system. The server-side software includes a web service module (for example, an HTTP/HTTPS interface), a natural language processing module, an image analysis module, an emotion analysis module, a location service interface module, a dialog management module, a generative AI interface module, a data store interface module, and a presentation generation module. The server stores configuration data, learned model parameters, and logs in a structured data store such as a relational database and a key-value store.

The terminal executes client-side application software on an operating system such as a mobile device operating system or an embedded automotive operating system. The terminal software includes a user interface module for presenting options and messages, an input capture module for capturing text, voice, and images, a sensor access module for reading positioning signals and other sensors, a local pre-processing module, and a communication module for sending and receiving data to and from the server via a communication network. The user operates the terminal to provide linguistic information and non-linguistic information. The user enters linguistic information as natural language text via a keyboard or as speech via the microphone. The terminal performs speech-to-text conversion using a local acoustic model and language model, and sends the converted text to the server. The user also provides non-linguistic information by capturing surrounding images or facial images via the camera, and by allowing the terminal to provide current location signals from the positioning module.

The server uses specific software components to perform data processing and data computation. The server uses a natural language processing library such as a tokenization and part-of-speech tagging tool to convert user linguistic information into structured feature vectors. The server uses an embedding model, for example a transformer-based encoder trained on text corpora, to map sentences into a fixed-dimensional vector space. The server then uses one or more feed-forward neural network layers to classify the intent of the user and detect a set of constraint conditions. These constraint conditions include, but are not limited to, item categories, preference parameters, budget ranges, and distance limits.

The server uses an emotion analysis module to identify a user emotion state. The emotion analysis module reads user linguistic information and facial image information and converts them into feature representations. For text, the server uses sentiment features such as word polarity scores, syntactic dependency patterns, and contextual embeddings from a transformer encoder. For images, the server uses a convolutional neural network with multiple convolution layers, pooling layers, and fully connected layers to extract facial features such as eye openness, mouth curvature, and facial muscle activation patterns. The server then inputs the extracted features into an emotion classifier network that outputs a probability distribution over discrete emotion labels such as joy, sadness, anger, and fatigue. The server stores the predicted emotion state and confidence score in the internal query information.

The server represents internal query information as a structured data object in memory. In one example, the internal query information includes fields for an intent identifier, a list of constraint key-value pairs, a current position vector, an emotion state label, and a set of metadata fields such as timestamps and terminal identifiers. The server maintains this internal query information as a persistent object across multiple user turns in a dialog session.

The server uses a generative AI model that is implemented as a large-scale neural network. In one embodiment, the generative AI model is a transformer-based language model including a stack of self-attention layers, feed-forward layers, layer normalization units, and residual connections. The model is trained on a large corpus of text with an autoregressive objective function that minimizes a cross-entropy loss between predicted next tokens and ground truth tokens. The server stores the model weights in memory and executes the model on the processor and optional accelerator.

The server generates a prompt sentence and passes the prompt sentence along with context tokens to the generative AI model. The server controls the generative AI model by specifying decoding parameters such as maximum length, temperature, and top-k or nucleus sampling thresholds. The server uses the output sequence produced by the generative AI model as a response sentence or as an intermediate structured output that is parsed back into internal data structures.

The server uses specific prompt sentences for different purposes. For extracting intent and constraints, the server uses a prompt sentence such as: “User input: ‘I want to eat curry’. Extract the main intent and all relevant constraint conditions such as food type, spiciness, budget, distance limit, and time. Output a concise explanation in natural language.”

For generating follow-up questions, the server uses a prompt sentence such as:

“The current intent is to find a restaurant for curry. Missing constraints are spiciness and budget. Generate short follow-up questions to ask the user about these missing constraints.”For adjusting dialog tone based on emotion, the server uses a prompt sentence such as:

“The user appears frustrated. Rewrite the following explanation in a more polite and empathetic tone, keeping it concise and clear.”

The server integrates the generative AI model outputs with deterministic processing logic.

The server receives a natural language explanation from the generative AI model, then parses the explanation using a rule-based parser to extract structured fields if needed. The server merges these structured fields into the internal query information data object. In this way, the generative AI model is not used merely as a black box oracle, but as a controlled component whose outputs are systematically mapped into machine-readable data structures used by downstream computation modules.

The server interfaces with location-related information processing resources and external information providing resources. The server uses an application programming interface of a mapping service to request candidate location information based on a current position vector and specified filters. The server defines the filter parameters by reading constraint conditions from the internal query information and mapping them to query parameters such as maximum distance radius, price range codes, and open-now conditions. The server sends this query via the location service interface module and receives structured results describing candidate points of interest, each including coordinates, category labels, ratings, and other attributes.

The server performs additional computation to rank and filter candidate location information.

The server computes a score for each candidate point of interest based on a weighted combination of relevance to intent, distance, rating, and compatibility with constraint conditions and emotion state. The server uses a scoring function, for example, a linear or non-linear function that takes as input normalized attribute values and outputs a scalar score.

The server then sorts the options by descending score and selects a subset of the top-ranked options to be presented to the user.

The server uses the emotion state not only to adjust wording, but also to adjust technical parameters of the scoring function. For example, when the emotion state indicates fatigue, the server increases the weight assigned to distance and decreases the weight assigned to rating, thereby favoring closer options over higher-rated but distant options. This adjustment changes the computational behavior of the ranking algorithm and results in a different selection of options, which is a technical modification of the option generation process conditioned on emotion.

The server also uses an image analysis resource to estimate user current position when explicit positioning information is degraded or unavailable. The server receives a surrounding image from the terminal and passes the image through a feature extraction pipeline. The feature extraction pipeline uses a convolutional neural network to compute intermediate feature maps and detect landmarks or distinctive objects. The server then compares the extracted feature vectors with a pre-computed database of feature vectors associated with known locations. The server calculates similarity scores using a distance metric such as cosine similarity or Euclidean distance and identifies one or more candidate positions with highest similarity. The server then produces an estimated position vector that is used as current position information in the internal query information. This procedure allows the system to maintain location-dependent processing even when satellite-based positioning signals are weak.

The terminal interacts with the user by displaying options and guidance in forms that are not limited to map coordinates. The terminal receives presentation information from the server that includes response sentences, lists of options, and configuration parameters indicating whether to use route description sentences, landmark-based guidance sentences, or step-by-step action instruction sentences. The terminal renders these sentences on the display and may use a text-to-speech engine to speak them. The user can choose options or continue the dialog by providing additional input.

The server explicitly generates different guidance expressions depending on the user's ability to understand map displays and on the emotion state. For a user who is determined to have difficulty with position display information, the server constructs prompt sentences such as:

“The user has difficulty reading maps. Based on the current position and destination, generate a step-by-step route description using plain language and visible landmarks.”

The generative AI model outputs narrative guidance such as directional instructions based on street names and landmarks. The server then stores these instructions in the presentation information data structure and sends them to the terminal. This processing transforms route polylines and coordinate data into a human-readable instruction sequence in a way that leverages both deterministic geographic computation and generative language synthesis.

The server improves computer technology in several ways. By maintaining internal query information as a persistent structured object and by using iterative calls to the generative AI model with explicit prompt sentences, the server reduces redundant external queries and accelerates convergence to relevant options. The server thereby reduces total computation time and network traffic compared to naive repeated broad searches. By using image-based position estimation integrated into the same query pipeline, the server maintains location context when traditional positioning resources fail, thereby reducing error cases and improving robustness of location-based services.

The server also improves data management by explicitly separating the roles of different modules. The natural language processing module, emotion analysis module, generative AI interface module, and location service interface module each operate on standardized data structures, which simplifies caching and re-use of intermediate results. For example, the server may cache feature embeddings for user text so that repeated related queries do not require recomputation. This modularization and caching reduce processing overhead and contribute to improved throughput.

The generative AI model itself is trained using a specific learning procedure. The server, during an offline training phase, collects supervised training data pairs consisting of input prompts and desired outputs. For the intent and constraint extraction behavior, the server constructs training examples where input prompts combine raw user text and instructions such as “extract intent and constraints,” and desired outputs are annotated descriptions. For dialog tone adjustment, the server constructs training examples where input prompts include tone descriptors such as “more polite” or “more empathetic,” and desired outputs are rewritten sentences. The server trains the model by minimizing a loss function such as cross-entropy between predicted and target token sequences, using gradient descent and weight updates such as Adam optimization. The server optionally applies data augmentation, for example paraphrasing of training sentences, to improve model robustness. These steps result in a generative AI model that behaves predictably under the specific prompt sentences used in the system.

The server uses non-conventional control logic to combine deterministic rules and generative AI outputs. The server does not simply replace human decisions with machine learning decisions in a direct one-to-one way. Instead, the server defines internal thresholds, fallback rules, and validation checks that operate on the outputs of the generative AI model. For example, the server checks that extracted constraint conditions conform to allowed ranges and types; if not, the server either requests clarification from the user or discards the inconsistent output. This hybrid design introduces a specific rule-based layer on top of model outputs, improving safety and computational reliability.

The server can be implemented in alternative embodiments. In one alternative, the emotion analysis is performed entirely on the terminal for privacy and efficiency, and only an abstract emotion label is sent to the server. In another alternative, the terminal performs local pre-ranking of candidate locations based on simple distance thresholds, and the server performs final ranking using the full scoring algorithm with emotion adjustment. In a further alternative, the generative AI model is deployed partially on the terminal for low-latency prompt processing in vehicle environments, while heavy image feature extraction remains on the server.

The described architecture is not limited to restaurant recommendation or navigation. The same server and terminal configuration can be applied to other categories of facilities and services, such as medical facilities, retail stores, or public services. In each case, the server uses the same internal query information structure, the same generative AI model interface, and the same emotion-aware ranking to generate options that are aligned with user intent, constraint conditions, and emotion state.

By combining a multi-module server architecture, a transformer-based generative AI model controlled via explicit prompt sentences, structured internal query data, multi-modal emotion and location analysis, and specific scoring and validation algorithms, the system implements more than an abstract idea. The system materially improves the functioning of the computer as a navigation and information provision machine by reducing error rates in location determination, by increasing speed and accuracy in option selection, by reducing redundant network traffic, and by dynamically controlling the flow and form of dialog according to computed internal states.

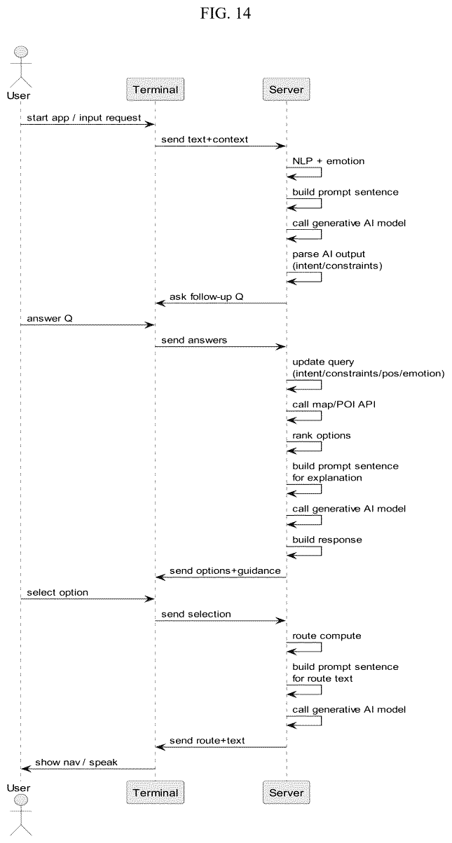

The following describes the processing flow using FIG. 14.
Step 1:

User operates the terminal and starts an application that connects to the server.

User provides initial input as natural language text via a keyboard or as speech via a microphone, for example “I want to eat curry” or “Where is the nearest gas station?”.

Input: raw user text or raw audio.

Terminal converts audio to text using a local speech-to-text engine, attaches a session identifier and timestamp, and stores the text in memory.

Output: normalized user text and associated session metadata.
Step 2:

Terminal acquires contextual non-linguistic information from onboard sensors.

Terminal reads positioning data from a positioning module and may also capture a surrounding image or a facial image via a camera when the user selects a camera option.

Input: sensor readings (positioning signals, time, device orientation) and image data from the camera.

Terminal formats the sensor readings and images into structured records (for example, latitude, longitude, accuracy, image byte arrays) and associates them with the same session identifier as the user text.

Output: structured context data including location candidates, image data, and session metadata.
Step 3:

Terminal transmits the combined user text and context data to the server.

Terminal constructs a request payload containing user text, session identifier, location information, and image data, and sends this payload via a communication interface over a network connection to the server.

Input: normalized user text, structured context data, and image data.

Terminal encapsulates the input into a communication protocol message and performs error checking and retry logic if a transmission failure occurs.

Output: network request carrying the session data to the server.
Step 4:

Server receives the request and performs initial parsing and validation.

Server reads the communication message, extracts user text, location fields, images, and session identifier, and validates data types and value ranges.

Input: communication message containing text, context fields, and images.

Server checks that required fields (user text, session identifier) are present, discards corrupted data, and stores valid records in a session store.

Output: validated session record containing user text, contextual fields, and references to stored images.
Step 5:

Server preprocesses the user linguistic information.

Server applies a natural language processing pipeline to the user text, including tokenization, lowercasing, part-of-speech tagging, and entity recognition.

Input: raw user text from the session record.

Server converts the text into a sequence of tokens, annotates tokens with syntactic and semantic tags, and generates an embedding vector representation suitable for downstream models.

Output: structured linguistic features including token list, tags, entities, and embeddings.
Step 6:

Server preprocesses the user non-linguistic information.

Server reads contextual fields such as location signals, device orientation, and timestamps, and normalizes them to a common coordinate system and time format.

Input: raw sensor data and metadata from the session record.

Server filters invalid location readings, interpolates or approximates missing values, and transforms coordinates if necessary; server stores the processed data as normalized context features.

Output: normalized non-linguistic feature set including a candidate current position vector and context attributes.
Step 7:

Server performs emotion analysis from linguistic and facial information.

Server passes the linguistic features to a text-based emotion analysis module and, if available, passes the facial image to an image-based emotion analysis module.

Input: tokenized text, text embeddings, and facial image data.

Server computes sentiment scores from the text and facial feature vectors from the image, feeds both into an emotion classifier network, and obtains a probability distribution over emotion labels; server selects a dominant emotion state and confidence value.

Output: discrete emotion state label (for example joy, frustration, fatigue) and associated confidence score.
Step 8:

Server determines user intent and initial constraint conditions.

Server uses a classifier or a generative AI model to map the linguistic features to an intent category such as “find restaurant”, “find gas station”, or “compute route”.

Input: structured linguistic features and context features.

Server computes classification scores for candidate intents, selects the highest-scoring intent, and identifies constraint conditions explicitly present in the text such as requested item type, basic budget expressions, or distance phrases.

Output: intent identifier and an initial list of extracted constraint conditions.
Step 9:

Server constructs a prompt sentence for deeper intent and constraint extraction.

Server embeds the user text, preliminary intent, and any available constraints into a structured prompt sentence for a generative AI model.

Input: initial intent, initial constraints, user text, and emotion state.

Server formats a prompt sentence such as “User input: ‘I want to eat curry’. Extract the main intent and all relevant constraint conditions such as food type, spiciness, budget, distance limit, and time, and describe them in plain language.” and stores this prompt sentence in memory.

Output: prompt sentence prepared for the generative AI model.
Step 10:

Server invokes the generative AI model to refine intent and constraints.

Server feeds the prompt sentence as tokens into the generative AI model and executes the model on the processor and optional accelerator to generate a response sequence.

Input: prompt sentence tokens and model parameters.

Server performs forward passes through the transformer layers, computes attention weights and token probabilities, decodes output tokens under specified sampling rules, and collects the generated text that describes intent and detailed constraints.

Output: generated descriptive text containing refined intent and constraint information.
Step 11:

Server parses the generative AI output into structured constraints.

Server feeds the generated descriptive text into a rule-based or shallow parsing module to map natural language phrases to structured fields.

Input: generated descriptive text from the generative AI model.

Server identifies specific attributes such as “spicy”, “under 1500”, or “within 3 kilometers”, converts these attributes into standardized constraint codes and numeric ranges, and merges them with the initial constraints while avoiding duplicates and conflicts.

Output: consolidated constraint condition set including type, budget range, distance limit, and other parameters.
Step 12:

Server identifies missing constraint conditions and prepares follow-up questions.

Server compares the consolidated constraint set against a predefined schema of recommended parameters for the current intent and detects missing or low-confidence fields.

Input: consolidated constraints and intent schema.

Server lists missing fields such as spiciness level or time preference, and constructs a prompt sentence such as “The current intent is to find a restaurant for curry. Missing constraints are spiciness and budget. Generate short follow-up questions to ask the user about these missing constraints.” for the generative AI model.

Output: prompt sentence requesting follow-up question generation and a list of missing constraints.
Step 13:

Server uses the generative AI model to generate follow-up questions.

Server executes the generative AI model with the follow-up prompt sentence to produce short question sentences directed to the user.

Input: follow-up question prompt sentence tokens.

Server performs token-level generation, stops when sentence termination criteria are met, and outputs natural language questions such as “What kind of curry do you like (mild, medium, or spicy)?” and “What is your budget per person?”.

Output: one or more follow-up question sentences.
Step 14:

Server sends follow-up questions to the terminal.

Server packages the follow-up questions into a response payload including the session identifier and emotion-appropriate display hints such as politeness level.

Input: generated follow-up questions and emotion state.

Server transmits the payload over the network; the server updates the session record to indicate that a clarification phase is active.

Output: network response containing follow-up questions and associated metadata.
Step 15:

Terminal presents follow-up questions and acquires additional user input.

Terminal displays the questions as chat bubbles or form fields and may use speech synthesis to read them aloud.

Input: follow-up question sentences and display hints.

User answers the questions via text or speech; terminal converts any speech to text, validates basic format (for example numeric budget), and associates the answers with the session identifier.

Output: additional user responses describing missing constraints.
Step 16:

Terminal transmits additional responses to the server.

Terminal constructs a supplemental message including the answers to follow-up questions and the session identifier and sends it to the server.

Input: additional user answers in text form and session metadata.

Terminal performs encoding and network transmission with error checking and retransmission if necessary.

Output: communication message containing follow-up answers received by the server.
Step 17:

Server updates internal query information with additional constraints.

Server reads the follow-up answers, parses them using lightweight linguistic analysis, and maps them to constraint fields such as “spiciness level =high” and “budget maximum =1500 units”.

Input: follow-up answers and existing internal constraint set.

Server merges the new constraints with existing ones, resolves conflicts by predefined priority rules, and stores the updated constraints in an internal query information object together with intent, emotion state, and position.

Output: complete internal query information object representing intent, constraints, emotion, and current position.
Step 18:

Server determines or refines current position information.

Server checks whether valid explicit positioning data is present and within an acceptable accuracy threshold.

Input: normalized non-linguistic features including explicit position, surrounding image data, and environment context.

If explicit position is missing or inaccurate, server passes the surrounding image to an image analysis pipeline, extracts visual feature vectors, compares them to a stored location feature database, and estimates a best-match position; server then updates the current position vector in the internal query information.

Output: reliable current position information associated with the user session.
Step 19:

Server queries external location-related and information resources.

Server constructs a query to a mapping or point-of-interest service using the current position, intent, and constraints as parameters.

Input: internal query information including position, intent, and constraints.

Server sends a structured request specifying search category, radius, price codes, and other filters, receives a set of candidate locations, and decodes them into candidate location objects with coordinates, labels, and attributes.

Output: candidate location information set aligned with the user's intent domain.
Step 20:

Server computes scores and selects options based on constraints and emotion.

Server applies a scoring algorithm that combines distance, rating, and constraint match, using weights that are adjusted according to the emotion state and intent.

Input: candidate location information and internal query information including emotion state.

Server normalizes each attribute (distance, rating, price) to a common scale, multiplies by corresponding weights, sums to a composite score for each candidate, sorts candidates by score, and selects a subset of top options as the option list to be presented.

Output: ordered list of options with associated scores and attributes.
Step 21:

Server prepares a prompt sentence for generating user-facing explanations.

Server converts the ordered option list and relevant session context into a textual description and embeds it in a prompt for the generative AI model.

Input: ordered options and emotion state.

Server builds a prompt sentence such as “The user is in a joyful mood and wants spicy curry under 1500 units. Here is a list of candidate restaurants with distance and rating. Generate a friendly explanation highlighting the top choices.” and encodes this sentence as tokens.

Output: explanation-generation prompt sentence.
Step 22:

Server uses the generative AI model to generate response and guidance sentences.

Server executes the generative AI model with the explanation prompt and generates natural language responses that describe the selected options and suggest actions.

Input: explanation prompt sentence tokens and model parameters.

Server produces multi-sentence output that includes overviews, comparisons, and informal comments adjusted to the emotion state; server terminates generation based on length and end-of-sequence criteria.

Output: response sentences describing options in an appropriate tone.
Step 23:

Server formats presentation information for the terminal.

Server merges the generated response sentences with the structured option list and adds display flags indicating whether to show maps, route description sentences, landmark-based guidance, or step-by-step instructions.

Input: response sentences, option list, and guidance format rules.

Server constructs a presentation payload that includes per-option text labels, coordinates, and any required route calculation parameters, and stores the payload for transmission.

Output: presentation information object ready to be sent to the terminal.
Step 24:

Terminal receives presentation information and renders options.

Terminal parses the presentation payload, extracts option details and response sentences, and updates the user interface to display lists, buttons, and textual guidance.

Input: presentation information object.

Terminal arranges options in the specified order, displays distances and brief descriptions, optionally invokes text-to-speech to read the response sentences, and prepares controls for user selection.

Output: rendered user interface showing options and associated guidance.
Step 25:

User selects an option and requests navigation or further action.

User taps an option on the display or confirms via voice, indicating a selected destination or choice.

Input: visual list of options and navigation controls.

Terminal captures the selection event, records the identifier of the chosen option, and optionally collects additional confirmation parameters such as preferred transport mode.

Output: user selection data to be used for route computation or action execution.
Step 26:

Terminal transmits the selected option to the server.

Terminal sends a message containing the selected option identifier, session identifier, and any additional parameters to the server.

Input: selection event data and session metadata.

Terminal encodes this information into a structured request and transmits it via the communication channel.

Output: selection request received by the server.
Step 27:

Server computes a route or execution plan for the selected option.

Server uses the current position and the selected option's location to request route information from a routing service.

Input: current position vector and destination coordinates from the selected option.

Server specifies routing parameters (for example walking or driving mode), receives a polyline route and step data, and converts them into a sequence of machine-readable steps with coordinates and textual summaries.

Output: route data and step sequence associated with the selected option.
Step 28:

Server generates user-friendly route descriptions adapted to user ability.

Server determines whether the user has difficulty understanding coordinate-based maps and chooses a guidance format accordingly.

Input: route data, user profile indicating map comprehension, and emotion state.

Server, if required, constructs a prompt sentence such as “The user has difficulty reading maps. Based on the following route segments, generate step-by-step instructions using nearby landmarks.” and invokes the generative AI model to produce human-readable route description sentences; server then associates each sentence with corresponding route segments.

Output: guidance sentences describing the route in landmark-based or step-wise form.
Step 29:

Server returns final navigation guidance to the terminal.

Server packages route coordinates, step definitions, and generated guidance sentences into a navigation payload.

Input: route step sequence and guidance sentences.

Server sends the payload over the network; in parallel, the server logs performance metrics such as route computation time and option acceptance rate for system optimization.

Output: navigation payload delivered to the terminal.
Step 30:

Terminal presents navigation instructions and interacts during movement.

Terminal renders the route on a map view if appropriate and displays or speaks the guidance sentences step by step as the user progresses.

Input: navigation payload including route geometry and guidance sentences.

Terminal monitors real-time position updates from the positioning module, compares the current position with route waypoints, highlights the next action in the guidance, and may send deviation alerts or updated position information back to the server for re-computation if the user moves off route.

Output: real-time navigation instructions and user feedback during travel.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

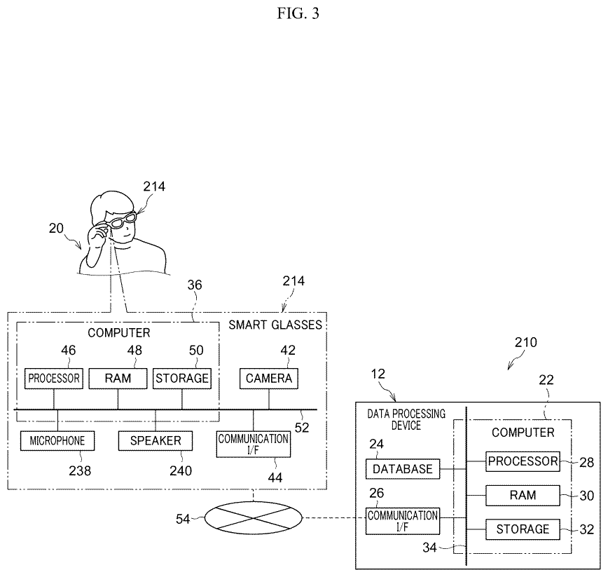

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

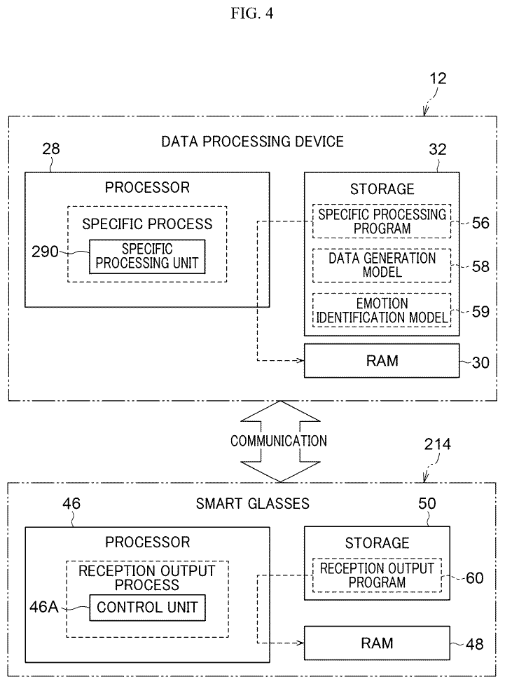

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

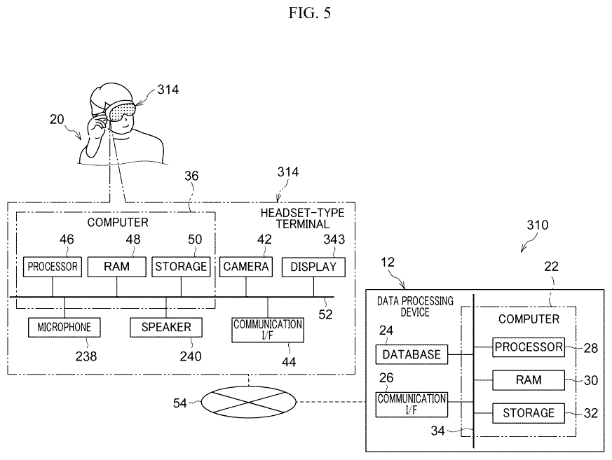

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

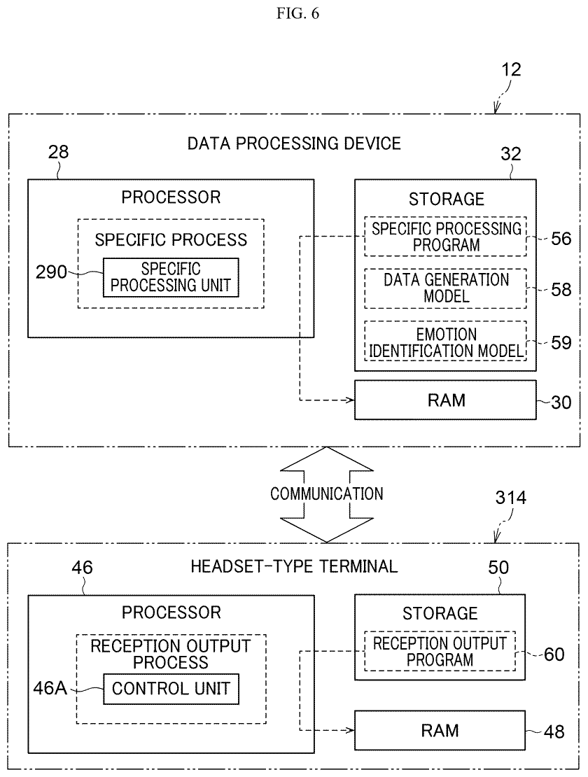

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

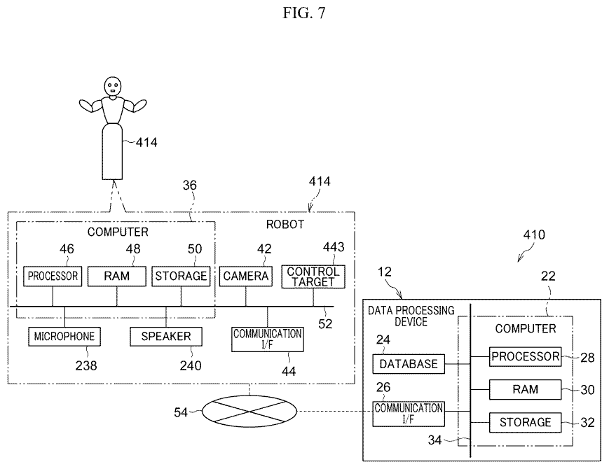

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

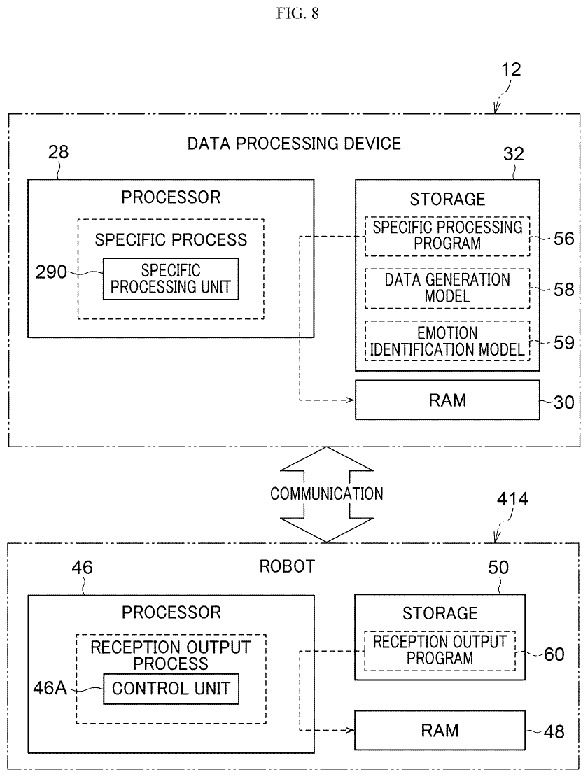

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

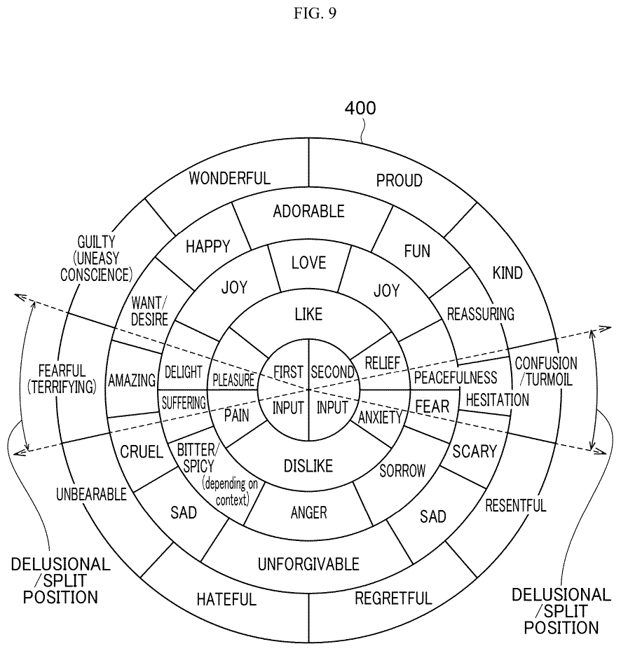

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https: //ci. nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

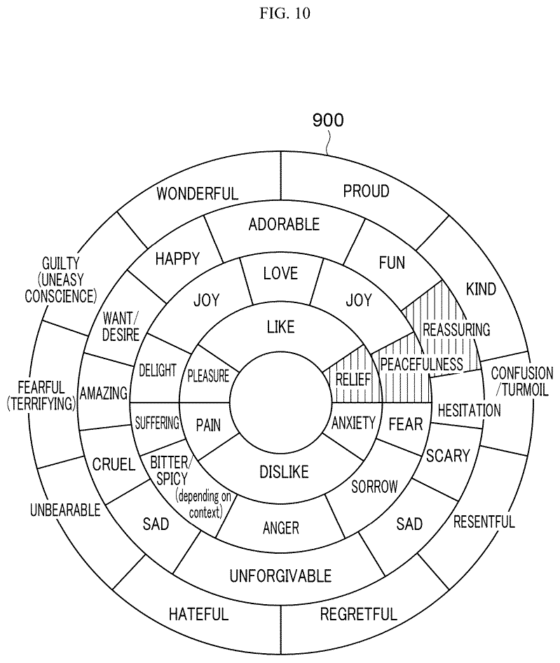

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire inquiry information expressed in natural language and position information from an information processing terminal operated by a user,
analyze an intention and a target category of the inquiry information based on the inquiry information and the position information, and generate a prompt sentence to be input to a generative AI model,
input the prompt sentence to the generative AI model and cause the generative AI model to generate response information in natural language to the inquiry information,
search an external geographic information database based on the response information and the position information, acquire related information including facility information and position information from the external geographic information database, and integrate the related information with the response information,
generate conversational explanation information and map display data based on the response information and the related information, and transmit the conversational explanation information and the map display data to the information processing terminal, and analyze an emotional state of the user from an expression included in the inquiry information, and adjust content or tone of at least one of the prompt sentence and the response information according to the emotional state.

### Supplementary 2

The system according to supplementary 1,
wherein the processor is configured to
when the intention of the inquiry information is determined to relate to a food service facility, generate, as the prompt sentence to be input to the generative AI model, a prompt sentence including the position information and a type of the food service facility, acquire facility information of a plurality of food service facilities from the external geographic information database, and generate the response information and the map display data based on the facility information.

### Supplementary 3

### The System According to Supplementary 1,

wherein the processor is configured to
when the intention of the inquiry information is determined to request support for understanding geographic information and to be support for a user having difficulty reading a map, generate, as the prompt sentence to be input to the generative AI model, a prompt sentence including the position information and features of a surrounding environment, cause the generative AI model to generate a plurality of options including the position information and guidance explanation information for a route, and convert the guidance explanation information into conversational explanation information to be presented to the user and transmit the conversational explanation information to the information processing terminal.

### Application Example 1

### Supplementary 1

A system comprising a processor,
wherein the processor is configured to
receive inquiry information expressed in natural language and location information from a user terminal,
input a prompt sentence to a generative AI model in order to analyze the inquiry information as text data and extract a facility type and a requested attribute from the inquiry information, search, by using a function of a geographic information providing service on the basis of the location information and the facility type, for facility information of surrounding facilities and acquire, as the facility information, identification information of a facility, position information of the facility, and operation time information of the facility,
organize the facility information as structured data, and input a prompt sentence including the structured data and the inquiry information to the generative AI model to generate a response sentence in a conversational format,
transmit the response sentence as chat-format text data to the user terminal so as to provide the facility information without displaying a map image, and
analyze emotion information of a user on the basis of contents of the inquiry information and the response sentence, and adjust expression of at least one of the prompt sentence and the response sentence in accordance with the emotion information.

### Supplementary 2

The system according to supplementary 1,
wherein the processor is configured to, when the facility type corresponds to a food and beverage providing facility, use the function of the geographic information providing service to acquire facility information of a plurality of food and beverage providing facilities, generate structured data including the facility information of the plurality of food and beverage providing facilities, and input a prompt sentence based on the structured data to the generative AI model to generate a response sentence in a conversational format including a plurality of options.

### Supplementary 3

The system according to supplementary 1,
wherein the processor is configured to, when a user is determined to be a user having difficulty in interpreting graphical information, generate explanation data including direction information, distance information, and route outline information on the basis of the location information and the facility information, and input a prompt sentence including the explanation data to the generative AI model to generate a response sentence in a conversational format that explains position information on a map in textual form.

### Example 2

### Supplementary 1

A system comprising a processor,
wherein the processor is configured to
receive imaging information acquired from a user terminal, execute image analysis processing to obtain object information and character information included in the imaging information,
search an information storage device in which position information is stored, based on the object information and the character information, and determine a current position of a user, generate a prompt sentence including the current position of the user and request information in natural language acquired from the user, and input the prompt sentence to a generative AI model to extract intent information and search condition information corresponding to the request information,
search an external or internal information source based on the search condition information and acquire a plurality of candidate information items related to the current position of the user,
generate a prompt sentence including the plurality of candidate information items and the request information of the user, and input the prompt sentence to the generative AI model to generate description information relating to the plurality of candidate information items,
output the description information and the plurality of candidate information items to the user terminal, and
input a prompt sentence including utterance information in natural language acquired from the user to the generative AI model, extract an emotional state of the user, and adjust a representation format of the description information according to the emotional state.

### Supplementary 2

The system according to supplementary 1,
wherein the processor is configured to, when the search condition information includes condition information relating to a service providing facility for food and drink, search a facility information storage device as the external or internal information source and acquire, as the plurality of candidate information items, a plurality of information items relating to service providing facilities for food and drink existing in the vicinity of the current position of the user.

### Supplementary 3

The system according to supplementary 1,
wherein the processor is configured to, when the user is estimated to be a user having difficulty in interpreting positional diagram information, input to the generative AI model a prompt sentence including the current position of the user and position information relating to the plurality of candidate information items, cause the generative AI model to generate the description information or route guidance information that allows the position information to be visually easily understood, and output the description information or the route guidance information to the user terminal.

### Application Example 2

### Supplementary 1

A system comprising a processor,
wherein the processor is configured to
receive and preprocess user linguistic information and user non-linguistic information, input a prompt sentence to a generative artificial intelligence model on the basis of the preprocessed linguistic information, and extract a user intent and constraint conditions and identify missing constraint conditions,
input a prompt sentence to the generative artificial intelligence model in accordance with the missing constraint conditions, and generate additional input request sentences to be presented to the user,
generate internal query information by integrating a current position information of the user, the extracted intent, the constraint conditions, and an emotion state of the user on the basis of additional input from the user,
access a location-related information processing resource or an external information providing resource on the basis of the internal query information, acquire candidate location information, and extract, by computation, a plurality of options that match the user intent and the constraint conditions,
use an emotion analysis resource on the basis of the user linguistic information and user facial image information, and identify the emotion state of the user,
input a prompt sentence to the generative artificial intelligence model on the basis of the emotion state, the plurality of options, and the current position information, generate a response sentence in which presentation contents of the plurality of options and an expression format of a dialog sentence are adjusted, and generate presentation information to be presented to the user, and
when the current position information of the user is difficult to acquire by a positioning resource, input a surrounding image acquired from a user terminal to an image analysis resource, estimate the current position of the user on the basis of extracted feature information, and reflect the estimated current position in the internal query information.

### Supplementary 2

The system according to supplementary 1,
wherein the processor is configured to, when the candidate location information relates to a food and beverage providing facility, input a prompt sentence to the generative artificial intelligence model, generate a plurality of options of the food and beverage providing facility in accordance with a food preference of the user, a budget condition, and the current position information, and adjust a priority of the options and a tone of explanation sentences on the basis of the emotion state.

### Supplementary 3

The system according to supplementary 1,
wherein the processor is configured to, when the user is determined to have difficulty in understanding position display information, input a prompt sentence to the generative artificial intelligence model, and generate, on the basis of the current position information and destination information, options including at least one of a route description sentence abstracting coordinate information on a map, a guidance sentence based on landmarks, and a step-by-step action instruction sentence, and adjust an expression and a level of detail of the guidance in accordance with the emotion state.

What is claimed is:

1. A system comprising:
circuitry configured to:
receive, from a client terminal via a packet-switched network, inquiry data expressed in natural language and position data associated with a user;
analyze the inquiry data and the position data to extract intent information and a target category, and generate a first prompt sentence for a generative neural network model based on the intent information, the target category, and the position data;
input the first prompt sentence to the generative neural network model and obtain first response data in natural language comprising candidate information items corresponding to the intent information;
search a geographic information database based on the first response data and the position data, and acquire related information comprising entity records and location coordinates from the geographic information database;
integrate the related information with the first response data to generate combined result data associating each candidate information item with corresponding entity records and location coordinates;
generate conversational output data and map display data based on the combined result data, and transmit the conversational output data and the map display data to the client terminal via the packet-switched network; and
analyze an emotional state of the user based on expression data included in the inquiry data, and adjust at least one of content, tone, and level of detail of the conversational output data according to the emotional state.

2. The system according to claim 1, wherein the circuitry is configured to analyze the inquiry data by tokenizing the natural language text, extracting named entities and semantic features using a natural language processing model, and classifying the intent information into a predefined category set comprising facility types, service types, and information request types.

3. The system according to claim 2, wherein the circuitry is configured to generate the first prompt sentence by embedding the classified intent information, the target category, the position data, and user preference data stored in a database into a structured natural-language instruction, and to specify, within the first prompt sentence, an output format requiring the generative neural network model to return the candidate information items as structured records with attribute fields.

4. The system according to claim 3, wherein the circuitry is configured to validate the first response data by parsing the structured records returned by the generative neural network model, verifying conformance with the specified output format, and filtering candidate information items that do not satisfy a relevance threshold derived from the intent information.

5. The system according to claim 4, wherein the circuitry is configured to rank the validated candidate information items based on a composite score computed from a relevance score assigned by the generative neural network model, a distance metric between the position data and location coordinates of each candidate, and the user preference data.

6. The system according to claim 1, wherein the circuitry is configured to search the geographic information database by transmitting query data comprising the target category and the position data to an external geographic information service via the packet-switched network, and receiving entity records comprising entity identifiers, entity names, location coordinates, operating hours, and category labels.

7. The system according to claim 6, wherein the circuitry is configured to match each candidate information item from the first response data with corresponding entity records from the geographic information database using string matching or semantic similarity comparison on entity names and category labels, and to associate matched entity records with the candidate information items in the combined result data.

8. The system according to claim 7, wherein the circuitry is configured to generate the map display data by computing display coordinates for each matched entity record based on the location coordinates and the position data, generating marker elements associated with the display coordinates, and formatting route information from the position data to each matched entity as directional guidance data.

9. The system according to claim 1, wherein the circuitry is configured to analyze the emotional state by extracting sentiment features and affective indicators from the inquiry data using a sentiment analysis model, mapping the extracted features to an emotion category comprising at least satisfaction, frustration, confusion, and neutral states.

10. The system according to claim 9, wherein the circuitry is configured to generate a second prompt sentence that incorporates the emotional state as a parameter, the second prompt sentence instructing the generative neural network model to adjust a response style such that when the emotional state indicates frustration, the conversational output data uses simplified language and prioritized results, and when the emotional state indicates satisfaction, the conversational output data includes additional detail and alternative options.

11. The system according to claim 10, wherein the circuitry is configured to monitor changes in the emotional state across a sequence of inquiry data received from the client terminal, and to progressively adjust the content and tone of subsequent conversational output data based on the detected emotional trajectory.

12. The system according to claim 1, wherein the circuitry is configured to receive image data from the client terminal via the packet-switched network, execute image analysis processing on the image data to extract object information and text information, search a position information database based on the object information and the text information, and determine a refined position of the user based on the search results.

13. The system according to claim 12, wherein the circuitry is configured to generate the first prompt sentence based on the refined position determined from the image analysis, and to include landmark descriptions extracted from the image data as contextual information within the first prompt sentence.

14. The system according to claim 1, wherein the target category relates to a food service facility, and the circuitry is configured to generate the first prompt sentence to instruct the generative neural network model to generate candidate dining facility information comprising facility names, cuisine categories, price range indicators, and user review summaries as the candidate information items.

15. The system according to claim 14, wherein the circuitry is configured to filter the candidate dining facility information based on dietary preference data and budget constraint data received from the client terminal, and to prioritize facilities that satisfy the dietary preference data in the combined result data.

16. The system according to claim 1, wherein the intent information indicates a request for navigation support, and the circuitry is configured to generate the first prompt sentence to instruct the generative neural network model to generate route guidance data comprising landmark-based directional descriptions adapted for a user having difficulty interpreting map displays.

17. The system according to claim 1, wherein the circuitry is configured to store interaction history data comprising past inquiry data, selected candidate information items, and associated emotional state data in the database, and to incorporate the interaction history data into subsequent prompt sentences to improve personalization of the conversational output data.

18. A system comprising:
circuitry configured to:
receive, from a client terminal via a packet-switched network, inquiry data in natural language and position data associated with a user;
analyze the inquiry data to extract intent information and a target category;
generate a first prompt sentence based on the intent information, the target category, and the position data;
input the first prompt sentence to a generative neural network model and obtain first response data;
search a geographic information database based on the first response data and the position data to acquire entity records and location coordinates;
integrate the first response data with the entity records to generate combined result data;
generate conversational output data and map display data based on the combined result data;
analyze an emotional state of the user based on expression data in the inquiry data;
adjust at least one of content and tone of the conversational output data based on the emotional state; and
transmit the conversational output data and the map display data to the client terminal via the packet-switched network.

19. The system according to claim 18, wherein the circuitry is configured to receive selection data from the client terminal indicating a user-selected candidate from the combined result data, store the selection data as interaction history, and incorporate the interaction history into subsequent prompt sentences for the generative neural network model.

20. A method performed by circuitry, the method comprising:
receiving, from a client terminal via a packet-switched network, inquiry data in natural language and position data associated with a user;
analyzing the inquiry data to extract intent information and a target category;
generating a first prompt sentence based on the intent information, the target category, and the position data;
inputting the first prompt sentence to a generative neural network model and obtaining first response data;
searching a geographic information database based on the first response data and the position data to acquire entity records and location coordinates;
integrating the first response data with the entity records to generate combined result data;
generating conversational output data and map display data based on the combined result data;
analyzing an emotional state of the user based on expression data in the inquiry data;
adjusting at least one of content and tone of the conversational output data based on the emotional state; and
transmitting the conversational output data and the map display data to the client terminal via the packet-switched network.
